(19) United States
(12) Patent Application Publication
(10) Pub. No.: US 2022/0101213 A1
(43) Pub. Date: Mar. 31, 2022

(54) METHOD OF PERFORMING DISPLAY WITH RESPECT TO CONTROL PARAMETERS FOR ROBOT, PROGRAM, AND INFORMATION PROCESSING APPARATUS

(71) Applicant: SEIKO EPSON CORPORATION, Tokyo (JP)

(72) Inventors: Kimitake MIZOBE, CHINO-SHI (JP); Ryutaro SEKI, SHIOJIRI-SHI (JP); Atsushi TOYOFUKU, SHIOJIRI-SHI (JP); Jun TODA, SHIOJIRI-SHI (JP)

(21) Appl. No.: 17/482,457

(22) Filed: Sep. 23, 2021

(30) Foreign Application Priority Data
Sep. 25, 2020 (JP) 2020-161005

(51) Int. Cl. G06Q 10/04; G06F 30/20

(52) U.S. Cl. CPC G06Q 10/04; G06F 2111/06; G06F 30/20

(57) ABSTRACT

(a) Determine first, second indexes. (b) Acquire values of the first, second indexes after a robot works using a parameter set. (c) Determine a new parameter set using a multi-objective optimization technique with a function containing the first, second indexes as an objective function. (d) Acquire values of the first, second indexes using the new parameter set. (e) Acquire parameter sets and values of the first, second indexes thereof by repeating (c), (d). (f) Perform display based on the values of the first, second indexes with respect to two or more of the parameter sets. The value of the first index of the first parameter set is better than the value of the first index of the second parameter set. The value of the second index of the second parameter set is better than the value of the second index of the first parameter set.

The present application is based on, and claims priority from JP Application Serial Number 2020-161005, filed Sep. 25, 2020, the disclosure of which is hereby incorporated by reference herein in its entirety.

### BACKGROUND

### 1. Technical Field

The present disclosure relates to a method of performing display with respect to control parameters for a robot, a program, and an information processing apparatus.

### 2. Related Art

In related art, there are techniques of setting control parameters for robots. In a technique of JP-A-2003-103482, a server computer derives a plurality of adjustment parameters according to purposes for optimization including “priority for shortening of motion time”, “priority for trajectory accuracy”, and “priority for minimization of energy consumption”. Optimization effects are computed for the respective calculated adjustment parameters. An operator confirms the optimization effects and selects an adjustment parameter to introduce. A robot control board changes data of the current adjustment parameter to data of the adjustment parameter received from the server computer.

In the technique described in JP-A-2003-103482, the plurality of adjustment parameters optimized for the respective single purposes are presented to the operator, and the operator selects one of the adjustment parameters.

However, when a parameter for controlling the motion of the robot is actually set, the parameter is set for realization of values that may satisfy all of a plurality of evaluation indexes in a trade-off relationship, e.g. motion time and trajectory accuracy. Accordingly, when the technique of JP-A-2003-103482 is used, the following problems arise. For example, regarding a parameter A obtained with “priority for shortening of motion time” as the optimization effect, the value of “trajectory accuracy” may be out of an acceptable range for a user. On the other hand, regarding a parameter B obtained with “priority for trajectory accuracy” as the optimization effect, the value of “motion time” may be out of an acceptable range for the user. That is, in the technique of JP-A-2003-103482, it may be hard to obtain a parameter that can realize the satisfactory values with respect to all of the plurality of evaluation indexes.

Further, the following situations may be caused. The user initially considered “motion time” as the evaluation index having the highest priority. However, regarding the parameter A obtained with “priority for shortening of motion time” as the optimization effect, the value of “motion time” was sufficiently satisfactory, but the value of “trajectory accuracy” was out of an acceptable range for the user. On the other hand, regarding the parameter B obtained with “trajectory accuracy” as the optimization effect, the value of “motion time” was worse than the value of “motion time” of the parameter A, but within the acceptable range for the user. Further, the value of “trajectory accuracy” was sufficiently satisfactory. Accordingly, the user employed the parameter B obtained with “trajectory accuracy” as the optimization effect, not “motion time” initially considered as the evaluation index having the highest priority. That is, in a process of determining the parameter to be finally employed, a change of the purpose may be required and the procedure may be complex.

Inventors of this application altered the technique of JP-A-2003-103482 and studied a configuration that derives a set of parameters by optimization with a weighted sum of a plurality of evaluation indexes as an optimization purpose. According to the configuration, parameters that can satisfy all of the plurality of evaluation indexes may be obtained by optimization processing with respect to one purpose. However, it is not easy to determine appropriate weights for the plurality of evaluation indexes in advance in order to obtain the weighted sum of the plurality of evaluation indexes.

### SUMMARY

According to an aspect of the present disclosure, a method of performing display with respect to parameters of a robot is provided. The method includes (a) determining a first index and a second index for evaluation of a control result of the robot, (b) acquiring a value of the first index and a value of the second index when the robot is moved using a parameter set for control of the robot, (c) determining a new parameter set using a multi-objective optimization technique with a function containing the first index and the second index as an objective function based on the parameter set and the acquired value of the first index and value of the second index, (d) acquiring the value of the first index and the value of the second index when the robot is moved using the new parameter set, (e) acquiring a plurality of parameter sets and values of the first index and values of the second index of the respective plurality of parameter sets by repeatedly executing (c) and (d), and (f) performing display based on the respective values of the first index and values of the second index with respect to two or more parameter sets of the plurality of parameter sets on a display unit, the two or more parameter sets include a first parameter set and a second parameter set, and the first parameter set and the second parameter set satisfy at least one of conditions that the value of the first index of the first parameter set is better than the value of the first index of the second parameter set, and the value of the second index of the second parameter set is better than the value of the second index of the first parameter set.

### BRIEF DESCRIPTION OF THE DRAWINGS

FIG. 1 is an explanatory diagram showing a robot system of one embodiment of the present disclosure.

FIG. 2 is a block diagram showing relationships among a functional block of a control apparatus 40, robots 1 to 3, and an optical system 20.

FIG. 3 shows motion parameters 44c.

FIG. 4 shows an example of a velocity of TCP controlled according to acceleration and deceleration characteristics.

FIG. 5 is a graph showing a relationship between a reference target acceleration Ast of the TCP included in the acceleration characteristics of the TCP and inertia I.

FIG. 6 is a block diagram showing a configuration of a setting apparatus 600.

FIG. 7 is a flowchart showing processing of optimizing parameters of the robot.

FIG. 8 is a graph showing a position of the TCP at an end of motion.

FIG. 9 is a graph showing magnitude of sound (dB) generated when the robot executes motion with a frequency along a horizontal axis.

FIG. 10 shows a user interface window I211 displayed on a display 602 of the setting apparatus 600 at step S205 in FIG. 7.

FIG. 11 shows a user interface window I251 shown at step S250.

FIG. 12 shows an objective function space of Bayesian optimization processing at step S210 in FIG. 7.

FIG. 13 shows a user interface window I252 shown at step S250 in FIG. 7.

FIG. 14 shows a user interface window I253 shown at step S250 in FIG. 7.

FIG. 15 shows a user interface window I254 shown at step S250 in FIG. 7.

FIG. 16 is a graph showing characteristics of parameter sets obtained in the processing to step S240.

FIG. 17 is a flowchart showing processing of optimizing parameters of the robot in Embodiment 5.

FIG. 18 shows a user interface window I255 shown at step S250 in FIG. 17.

FIG. 19 is a block diagram showing configurations of a setting apparatus 600 and a robot 3 in Embodiment 6.

FIG. 20 shows a user interface window I212 displayed on the display 602 of the setting apparatus 600 at step S205 in FIG. 7.

### DESCRIPTION OF EXEMPLARY EMBODIMENTS

### A. Embodiment 1

### A1. Configuration of Robot System:

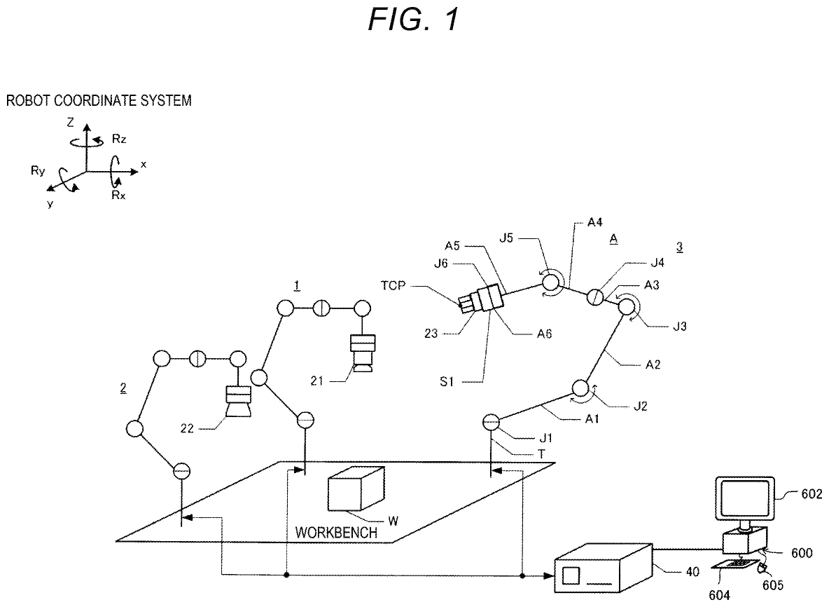

FIG. 1 is an explanatory diagram showing a robot system of one embodiment of the present disclosure. The robot system as the one embodiment of the present disclosure includes robots 1 to 3, a control apparatus 40, and a setting apparatus 600.

The control apparatus 40 controls the robots 1 to 3. The control apparatus 40 is communicably coupled to the robots 1 to 3 by cables. The control apparatus 40 includes a CPU as a processor, a RAM, and a ROM. The CPU of the control apparatus 40 moves the robots by loading and executing computer programs stored in the ROM in the RAM.

The setting apparatus 600 generates a motion program specifying motion of the robots 1 to 3 and sets parameters of the motion program. The setting apparatus 600 is communicably coupled to the control apparatus 40 by a cable. The motion program generated by the setting apparatus 600 is transmitted to the control apparatus 40. The control apparatus 40 moves the robots 1 to 3 according to the motion program received from the setting apparatus 600. The configuration of the setting apparatus 600 will be described later.

The robots 1 to 3 are general-purpose robots configured to perform various kinds of work by teaching. More specifically, the robots 1 to 3 are single-arm robots used with various end effectors attached to arms A. The robots 1 to 3 are six-axis robots including end effectors 21, 22, 23 different from one another, respectively. In the embodiment, the configurations of the arms A and axes are equal in the robots 1 to 3.

With the robot 3 as an example, the configurations of the robots 1 to 3 will be explained. The robot 3 includes a base T, six arm members A1 to A6, and six joints J1 to J6. The base T is fixed to a workbench. The base T and the six arm members A1 to A6 are coupled by the joints J1 to J6. In the embodiment, the joints J2, J3, J5 are bending joints and the joints J1, J4, J6 are twisting joints. The rotation axes in the respective joints J1 to J6 are also referred to as “operation axes” in this specification.

The end effector is attached to the arm member A6 located at the distal end in the arm A. The robots 1 to 3 may place the end effectors in arbitrary positions within predetermined ranges in arbitrary attitudes, i.e., at arbitrary angles by driving the six-axis arms A.

The end effectors different from one another are attached to the robots 1 to 3. The end effector attached to the robot 1 is an imaging unit 21. The imaging unit 21 may capture an image within a field of view. The imaging unit 21 includes a mechanism that can adjust the exposure time and the aperture. The end effector attached to the robot 2 is an illumination unit 22. The illumination unit 22 may irradiate a radiation range with light. The illumination unit 22 includes a mechanism that can adjust brightness. Hereinafter, the imaging unit 21 and the illumination unit 22 are also referred to as “optical system”. The end effector attached to the robot 3 is a gripper 23. The gripper 23 may grip an object W.

In the embodiment, positions fixed relative to the end effectors of the robots 1 to 3 are defined as tool center points (TCPs). The position of the TCP is a reference position for the end effector. A TCP coordinate system is defined with the TCP on the origin. The TCP coordinate system is a three-dimensional orthogonal coordinate system fixed relative to the end effector.

An acceleration sensor S1 is attached together with the end effector to the arm member A6 located at the distal end in the arm A. The acceleration sensor S1 may acquire information of accelerations in directions of three axes orthogonal to one another and angular velocities around these axes. The control apparatus 40 recognizes an inclination of the end effector, a movement velocity including a speed and a direction of the end effector, and a current position of the end effector based on the information.

The coordinate system specifying the space in which the robots 1 to 3 are placed is referred to as “robot coordinate system” in this specification. The robot coordinate system is a three-dimensional orthogonal coordinate system defined by an x-axis and a y-axis orthogonal to each other on a horizontal plane and a z-axis along which a vertical upward direction is a positive direction (see the upper left part in FIG. 1). The negative direction along the z-axis coincides with the direction of gravity force. An arbitrary position in the three-dimensional space may be represented by positions in x, y, z directions. A rotation angle around the x-axis is shown by Rx, a rotation angle around the y-axis is shown by Ry, and a rotation angle around the z-axis is shown by Rz. An arbitrary attitude in the three-dimensional space may be represented by rotation angles in the Rx, Ry, Rz directions. Hereinafter, “position” may include the attitude.

In the embodiment, the relationships among the respective coordinate systems are defined in advance. As a result, coordinate values in the respective coordinate systems can be transformed to one another. That is, positions and vectors in the TCP coordinate system, the sensor coordinate system, and the robot coordinate system can be transformed to one another. Here, for ease of understanding of the technique, the explanation will be made with the control apparatus 40 controlling the position of the TCP in the robot coordinate system.

### A2. Control of Robot:

### (1) Configuration of Robot and Functions of Control Apparatus:

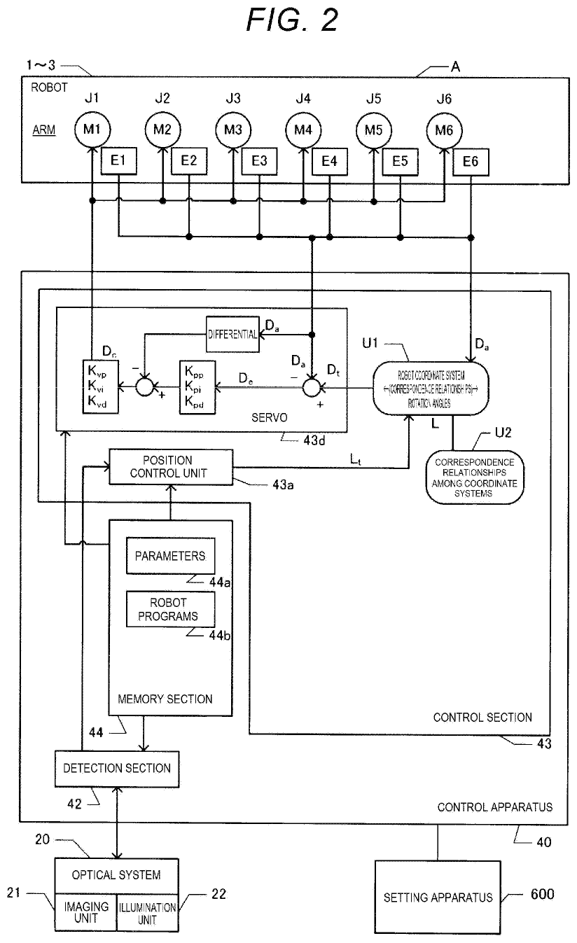

FIG. 2 is a block diagram showing relationships among a functional block of the control apparatus 40, the robots 1 to 3, and the optical system 20. Each of the robots 1 to 3 has motors M1 to M6 as actuators and encoders E1 to E6 as sensors.

The motors M1 to M6 drive the joints J1 to J6, respectively. Specifically, the control of the robot arm A is performed by control of the motors M1 to M6. In power supply lines that supply electric power to the respective motors M1 to M6, current meters are respectively provided. The control apparatus 40 may measure the currents supplied to the respective motors M1 to M6 via these current meters. The encoders E1 to E6 detect rotation angles of the motors M1 to M6, respectively.

The control apparatus 40 includes a memory section 44. The control apparatus 40 functions as a detection section 42 and a control section 43.

The detection section 42 is coupled to the imaging unit 21 and the illumination unit 22 forming the optical system 20. The detection section 42 detects an object and specifies the position and the attitude of the object. The control section 43 performs position control of the end effectors of the robots 1 to 3. As below, the position control of the end effectors will be explained.

### (2) Position Control of End Effector of Robot:

In the control section 43, a correspondence relationship U1 between a combination of the rotation angles of the motors M1 to M6 and the position of the TCP in the robot coordinate system are stored in a memory medium (not shown) (see the middle right part in FIG. 2). In the control section 43, a correspondence relationship U2 among the coordinate systems is further stored in the memory medium (not shown). Note that the correspondence relationships U1, U2 may be stored in the memory section 44.

The control section 43 may transform a vector in an arbitrary coordinate system to a vector in another coordinate system based on the correspondence relationship U2. For example, the control section 43 may acquire and transform the accelerations of the robots 1 to 3 in the sensor coordinate system based on the output of the acceleration sensors S1 to accelerations of the TCPs in the robot coordinate system.

The control section 43 controls the positions of the respective parts of the robots 1 to 3 by driving the arms A. The control section 43 includes a position control unit 43a and a servo 43d as functional units (see the middle part in FIG. 2).

### (i) Processing in Servo 43d:

The servo 43d executes servo control. More specifically, the servo 43d executes feedback control to set rotation angles Da of the motors M1 to M6 shown by the output of the encoders E1 to E6 and target angles Dt as control targets to be equal. The servo 43d executes PID control with respect to the position using a deviation De between the rotation angle Da and the target angle Dt, an integration of the deviation De, and a differential of the deviation De. In FIG. 2, proportional gain Kpp, integral gain Kpi, and differential gain Kpd are shown (see the middle left part in FIG. 2).

The servo 43d executes PID control with respect to the velocity using a deviation between the output of the PID control with respect to the position using the above described Kpp, Kpi, Kpd and the differential of the rotation angle Da, an integration of the deviation, and a differential of the deviation. In FIG. 2, proportional gain Kvp, integral gain Kvi, and differential gain Kvd are shown (see the middle left part in FIG. 2).

As a result of the above described processing, a control amount Dc is determined. The control amount Dc is determined with respect to each of the motors M1 to M6. The control section 43 controls the respective motors M1 to M6 using the control amounts Dc for the respective motors M1 to M6. Signals for controlling the motors M1 to M6 by the control section 43 are PWM (Pulse Width Modulation) modulated signals. Note that the servo gain Kpp, Kpi, Kpd, Kvp, Kvi, Kvd used by the servo 43d are parameters that may be changed. As below, the parameters of the robots 1 to 3 will be explained before explanation of the processing in the position control unit 43a.

### (ii) Parameters of Robot:

Various parameters 44a and robot programs 44b for controlling the robots 1 to 3 are stored in the memory section 44 (see the middle left part in FIG. 2). The robot programs 44b mainly show sequences of work performed by the robots 1 to 3, i.e., sequences of motion. The robot program 44b is described by a combination of commands defined in advance. The parameters 44a are specific values necessary for realization of respective motions. The parameters 44a are described as parameters of the respective commands. The servo gain Kpp, Kpi, Kpd, Kvp, Kvi, Kvd are part of the parameters 44a.

In the embodiment, the parameters 44a and the robot programs 44b are generated by teaching to the robots and stored in the memory section 44. The parameters 44a and the robot programs 44b stored in the memory section 44 may be corrected by the setting apparatus 600 (see the lower right part in FIG. 2).

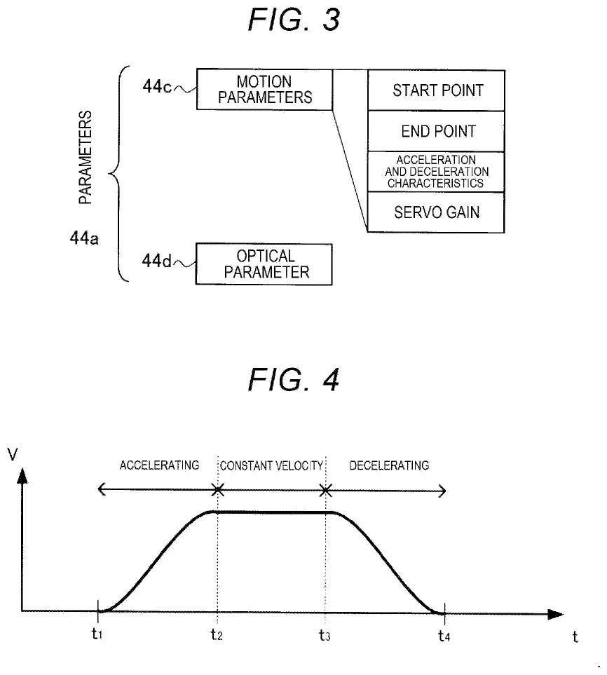

FIG. 3 shows motion parameters 44c. The motion parameters 44c form part of the parameters 44a. The parameters 44a include an optical parameter 44d in addition to the motion parameters 44c. The optical parameter 44d is a parameter for controlling the imaging unit 21 of the robot 1 and the illumination unit 22 of the robot 2. The motion parameters 44c are parameters with respect to the motions of the robots 1 to 3. The motion parameters 44c are referred to in the position control. A series of work by the robots 1 to 3 is divided into a plurality of motions. The motion parameters 44c when the respective motions are performed are generated by teaching.

The motion parameters 44c include parameters showing “start point” and “end point” in each motion. The start point and the end point may be defied in various coordinate systems. In the embodiment, “start point” and “end point” of the TCP of the robot to be controlled are defined in the robot coordinate system. A translational position and a rotational position with respect to each axis of the robot coordinate system are defined.

The motion parameters 44c include “acceleration and deceleration characteristics” of the TCP in the plurality of motions. The acceleration and deceleration characteristics specify velocities of the TCPs at the respective times when the TCPs of the robots 1 to 3 move from the start points to the end points of the respective motions.

FIG. 4 shows an example of the velocity of the TCP controlled according to the acceleration and deceleration characteristics. In FIG. 4, at each time from a movement start time t1 of the TCP at the start point to a time t4 at which the TCP reaches the end point, the velocity V of the TCP is specified. In the example of FIG. 4, the TCP accelerates at a target acceleration in a period from times t1 to t2, keeps the constant velocity in a period from times t2 to t3, and the TCP decelerates at a target acceleration in a period from times t3 to t4. In the embodiment, magnitude of an absolute value of a target acceleration at acceleration and magnitude of an absolute value of the target acceleration at deceleration are equal.

The acceleration and deceleration characteristics may be defied in various coordinate systems. In the embodiment, the velocity described by the acceleration and deceleration characteristics is a velocity with respect to the TCP of the robot to be controlled. The velocity of the TCP is defined in the robot coordinate system. That is, a translational velocity and a rotational velocity (angular velocity) with respect to each axis of the robot coordinate system are defined.

In the robots 1 to 3, shapes of the components of the robots at the distal end sides of certain joints may change depending on the angles of the joints at the distal end sides. Accordingly, inertia, i.e., inertial moment at the distal end sides of the certain joints of the robots 1 to 3 may change depending on the angles of the joints at the distal end sides. For example, when the six arm members A1 to A6 take an attitude arranged in a line, inertia of the rotation with reference to the joint J1 is the maximum (see FIG. 1). Concurrently, the center of gravity of the entire of six arm members A1 to A6 is located in a position farthest from the joint J1. On the other hand, when the arm A takes an attitude in which the center of gravity of the entire of six arm members A1 to A6 is closest to the joint J1, the inertia of the rotation with reference to the joint J1 is the minimum. An acceleration that may be realized by a motor changes depending on inertia of an object moved by the motor. Accordingly, the accelerations instructed by the motors driving the respective joints are determined according to the inertia at the distal end sides of the respective joints (see t1 to t2, t3 to t4 in FIG. 4). The acceleration of the TCP is determined in the following manner.

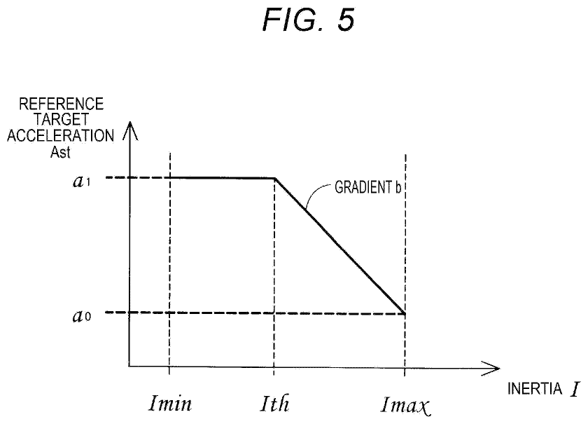

FIG. 5 is a graph showing a relationship between a reference target acceleration Ast of the TCP included in the acceleration characteristics of the TCP and inertia I. With respect to each of the joints J1 to J6, as one of the motion parameters 44c, a limited maximum acceleration a0 is determined. The limited maximum acceleration a0 is an acceleration that may be stationarily realized by the motor when the inertia I of the component of the robot at the distal end of the joint is the maximum value Imax. Further, with respect to each of the joints J1 to J6, as one of the motion parameters 44c, an upper limit maximum acceleration a1 is determined. The upper limit maximum acceleration a1 is an acceleration that may be stationarily realized by the motor when the inertia I of the component of the robot at the distal end of the joint is equal to or smaller than a predetermined value Ith. The inertia Ith is a value between the minimum value Imin and the maximum value Imax of the inertia of the component of the robot at the distal end of the joint. Note that the limited maximum acceleration a0 and the upper limit maximum acceleration a1 are determined on the assumption that the robot holds a predetermined rated load.

As seen from FIG. 5, when the inertia at the distal end of the joint is equal to or smaller than the predetermined value Ith, the reference target acceleration Ast takes a fixed value a1. When the inertia at the distal end of the joint is larger than the predetermined value Ith, the reference target acceleration Ast linearly decreases relative to the inertia at a gradient b. That is, b is a rate of change of the reference target acceleration Ast.

$$b = \{ ( a 0 - a 1 ) / ( I max - Ith ) \} \qquad ( Eq 1 )$$

Further, the reference target acceleration Ast is corrected according to the magnitude of the load held by the robot. A target acceleration At of the TCP is obtained by multiplication of the reference target acceleration Ast by a load correction factor CL (see t1 to t2, t3 to t4 in FIG. 4).

$$At = CL \times Ast \qquad ( Eq 2 )$$

For example, the load correction factor CL is determined by the following equation. When a load w held by the robot is a rated load w0, c=1. When the load w held by the robot is higher than the rated load w0, c<1. When the load w held by the robot is lower than the rated load w0, c>1.

$$\begin{matrix}c = \{ - ( w - w 0 ) / ( w max - w min ) \} + 1 \\ = d \times ( w - w 0 ) + 1\end{matrix}$$

where w is magnitude of the load held by the robot,
w0 is the rated load as reference,
wmax is the maximum value of the load that may be held by the robot, and
wmin is the minimum value of the load that may be held by the robot.

$$d = \{ - 1 / ( w max - w min ) \}$$

Parameters of the acceleration and deceleration characteristics as part of the motion parameters 44c include the limited maximum acceleration a0, the upper limit maximum acceleration a1, the gradient b of the reference target acceleration Ast, and a gradient d of the load correction factor CL (see FIG. 3). These parameters are optimized by processing, which will be described later, and thereby, changes of accelerations and decelerations of the operation axes may be automatically set with respect to each motion.

The motion parameters 44c include the servo gain Kpp, Kpi, Kpd, Kvp, Kvi, Kvd (see FIG. 3). The control section 43 adjusts the servo gain Kpp, Kpi, Kpd, Kvp, Kvi, Kvd applied by the servo 43d to be the values stored as the motion parameters 44c. In the embodiment, the values of the servo gain are determined with respect to each motion. Note that, in the optimization or the like, which will be described later, the servo gain may be determined with respect to each shorter period.

(iii) Processing in Position Control Unit 43a:

The position control unit 43a executes control of position. More specifically, the control section 43 controls the motors M1 to M6 at rotation angles derived by linear operation from a target position. A mode of controlling the motors M1 to M6 at the rotation angles derived by linear operation from the target position is referred to as “position control mode” in this specification.

When control is performed in the position control mode, the position control unit 43a determines a target position Lt with respect to each fine motion. The target position Lt with respect to each fine motion is obtained, and then, the control section 43 converts motion positions in the directions of the respective axes defining the robot coordinate system into the target angles Dt as target rotation angles for the respective motors M1 to M6 based on the target positions Lt and the correspondence relationship U1 (see the middle right part in FIG. 2).

The servo 34d acquires the servo gain Kpp, Kpi, Kpd, Kvp, Kvi, Kvd with reference to the parameters 44a and derives control amounts Dc based on the target angles Dt (see the middle left part in FIG. 2). The control amounts Dc are specified for the respective motors M1 to M6 and the motors M1 to M6 are respectively controlled by the control amounts Dc for the respective motors M1 to M6. As a result, in the respective motions, the TCP moves from the start point to the end point via the target positions Lt for the respective fine motions according to the acceleration and deceleration characteristics.

### A3. Configuration of Setting Apparatus:

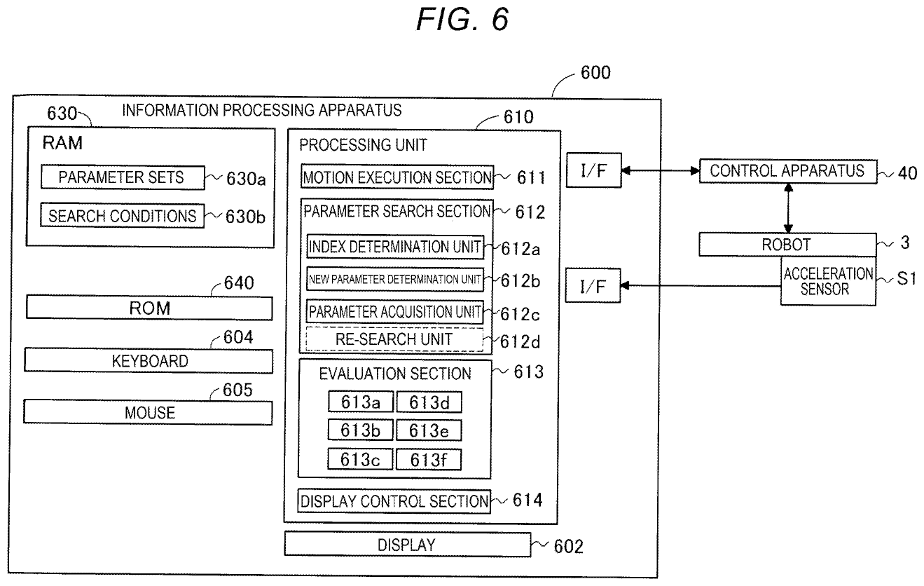

FIG. 6 is a block diagram showing a configuration of the setting apparatus 600. The setting apparatus 600 generates motion programs specifying the motions of the robots 1 to 3 (see the lower right part in FIG. 1). For ease of understanding of the technique, FIG. 6 shows only the robot 3 of the robots 1 to 3.

The setting apparatus 600 is a computer including a display 602 that functions as an output device, and a keyboard 604 and a mouse 605 that function as input devices. The setting apparatus 600 further includes a CPU 610 as a processor, a RAM 630, and a ROM 640. The CPU 610 realizes various functions including optimization processing of parameters by loading and executing the computer programs stored in a memory medium in the RAM 630. The setting apparatus 600 is coupled to the acceleration sensor S1 and the control apparatus 40 of the robot 3 via the interface.

### A4. Optimization Processing of Parameters:

### (1) Flow of Optimization Processing of Parameters:

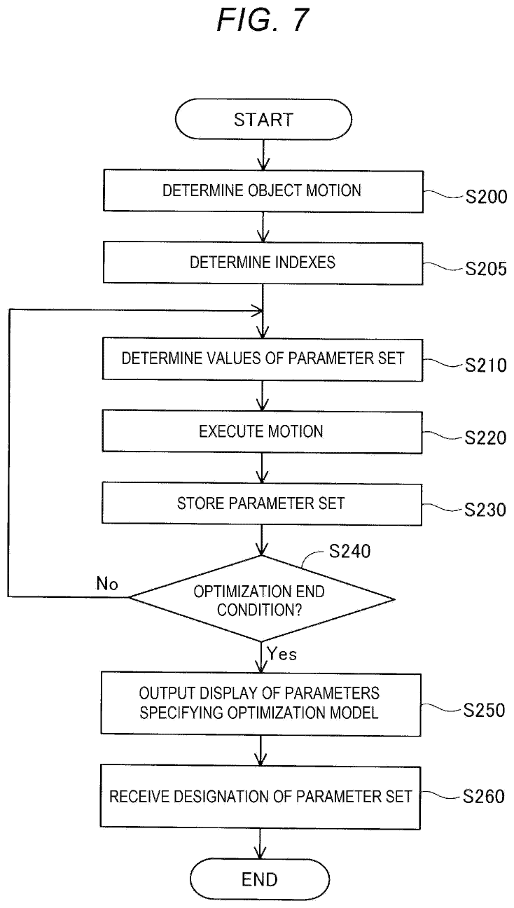

FIG. 7 is a flowchart showing processing of optimizing parameters of the robot. In the embodiment, prior to the operation of the robots 1 to 3, the parameters expressing the acceleration and deceleration characteristics and the parameters expressing the servo gain of the motion parameters 44c are optimized (see FIG. 3). A set of these parameters is referred to as “parameter set” in this specification. The processing in FIG. 7 is executed by the CPU 610 of the setting apparatus 600 (see the lower right part in FIG. 1 and FIG. 6).

At step S200, the CPU 610 determines motion having acceleration and deceleration characteristics and servo gain to be optimized according to an instruction from the user. Here, it is assumed that motion to move the object W held by the gripper 23 of the robot 3 from a certain point to another point is determined as the motion to be optimized (see FIG. 1).

At step S205, the CPU 610 determines a first index and a second index for evaluation of the control result of the robot 3. The first index and the second index are determined from the following indexes.

### (I-1) Motion Time:

A motion time refers to a required time from the start to the end of motion. In certain control, the shorter the motion time, the higher the evaluation of the control. The motion time may be determined based on the target positions of the TCP at the start and the end of the motion and the positions of the TCP at the respective times obtained from the encoders E1 to E6 (see the upper part in FIG. 2). The functional unit of the CPU 610 measuring the motion time is shown as “motion time measuring unit 613a” in FIG. 6.

### (I-2) Overshoot Amount:

An overshoot amount refers to the maximum value of a position difference of the TCP at the end of the motion. In certain control, the smaller the overshoot amount, the higher the evaluation of the control.

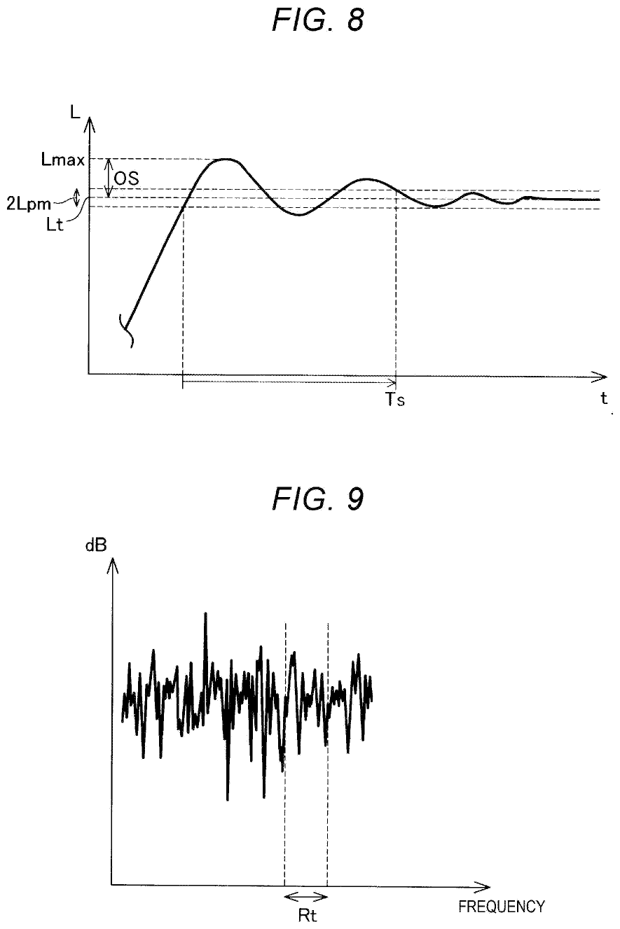

FIG. 8 is a graph showing the position of the TCP at the end of the motion. An overshoot amount OS is measured as a difference between the target position Lt of the TCP of the robot and an overshoot Lmax. The position difference of the TCP may be determined based on the target position Lt of the TCP at the end of the motion, positions L of the TCP before and after the end of the motion obtained from the encoders E1 to E6 (see the upper part in FIG. 2), and the output of the acceleration sensor S1 provided at the distal end of the arm of the robot. The functional unit of the CPU 610 measuring the overshoot amount is shown as “overshoot amount measuring unit 613b” in FIG. 6.

(I-3) Vibration Amount after End of Motion:

A vibration amount is evaluated by a total of absolute values of overrun amounts from the target positions to a time Ts when the position difference of the TCP after the end of the motion is smaller than a predetermined value Lpm. In certain control, the smaller the vibration amount after the end of the motion, the higher the evaluation of the control. The functional unit of the CPU 610 measuring the vibration amount is shown as “vibration amount measuring unit 613c” in FIG. 6.

### (I-4) Noise Level:

A noise level is magnitude of sound generated when the robot executes motion. In certain control, the lower the noise level, the higher the evaluation of the control.

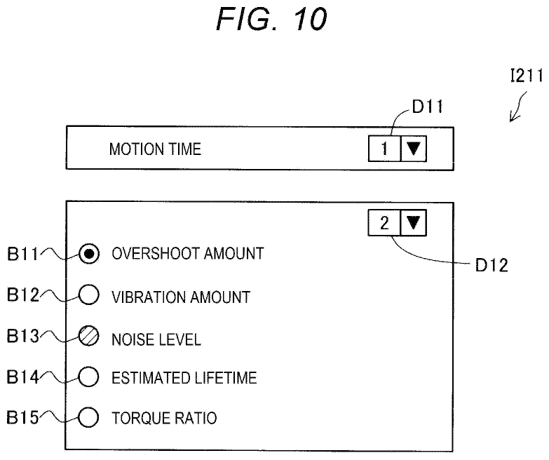

FIG. 9 is a graph showing magnitude of sound (dB) generated when the robot executes motion with a frequency along a horizontal axis. The noise level may be determined in the following manner. That is, sound may be collected using microphones provided near the respective robots, and the noise level may be determined based on magnitude of sound (energy amount) contained in a predetermined frequency band Rt. An evaluation index for “magnitude of sound” is determined, and thereby, parameters may be set to suppress sound unpleasant to the user. The functional unit of the CPU 610 measuring the noise level is shown as “noise level measuring unit 613d” in FIG. 6.

### (I-5) Estimated Lifetime:

An estimated lifetime L is calculated according to the following equation (Eq3). In certain control, the longer the estimated lifetime, the higher the evaluation of the control.

$$\begin{matrix}[ Math . 1 ] & \\ L = {L}_{1} \frac{{K}_{1}}{{( {K}_{2} )}^{3} * f} & ( Eq 3 )\end{matrix}$$

L₁: rated lifetime [hours]
K: rotation velocity coefficient

$${K}_{1} = \frac{reference input rotation velocity}{used input rotation velocity}$$

K₂: load rate

$${K}_{2} = \frac{used torque}{acceptable torque}$$

f: load type coefficient

TABLE 1

| | | Load Type |
|---|---|---|
| Load Type | Example | Coefficient f |
| Uniform Load | Unidirectional continuous operation | 1.0 |
| | Driving with less load variations in belt | |
| | conveyer, film take-up, etc. | |
| Low Impact | Frequent starts and stops | 1.5 |
| | Positioning control of inertial body | |
| | using cam drive, stepping motor etc. | |
| Medium Impact | Frequent instant forward and backward | 2.0 |
| | operations and starts and stops of | |
| | reversible motor | |
| | Frequent instant stops by brake back of | |
| | AC motor | |
| | Frequent instant starts and stops by | |
| | brushless motor, servo motor | |

The functional unit of the CPU 610 calculating the estimated lifetime is shown as “estimated lifetime calculation unit 613e” in FIG. 6.

### (I-6) Torque Ratio:

A torque ratio of each motor is obtained by [average of torque applied to output shaft during motion]/[acceptable torque value]. [Acceptable torque] refers to torque that the motor may continuously apply to the output shaft. [Acceptable torque] is determined with respect to each motor. [Average of torque applied to output shaft during motion] may be determined based on the output of the current meters measuring the currents flowing in the motors M1 to M6. In certain control, the smaller the torque ratio, the higher the evaluation of the control. The functional unit of the CPU 610 calculating the torque ratio is shown as “torque ratio calculation unit 613f” in FIG. 6.

FIG. 10 shows a user interface window I211 displayed on the display 602 of the setting apparatus 600 at step S205 in FIG. 7. The user interface window I211 contains buttons B11 to B15 and selection windows D11, D12.

In the user interface window I211, three or more indexes for evaluation of the control result of the robot 3 are displayed on the display 602. More specifically, the motion time is displayed in the upper part and the overshoot amount, the vibration amount, the noise level, the estimated lifetime, and the torque ratio are displayed in the lower part. The overshoot amount, the vibration amount, the noise level, the estimated lifetime, and the torque ratio are the indexes having tendencies that the motion time is longer as the evaluation is higher. That is, the overshoot amount, the vibration amount, the noise level, the estimated lifetime, and the torque ratio are the indexes having tradeoff relationships with the motion time.

The user may select “1” or “2” in the selection window D11. When the motion time is selected as the first index, the user selects “1” in the selection window D11. When the motion time is selected as the second index, the user selects “2” in the selection window D11.

In the embodiment, the button B13 for selection of the noise level is set to be unselectable. The user selects one of the buttons B11, B12, B14, B15 in the user interface window I211, and thereby, one index may be selected from the overshoot amount, the vibration amount, the estimated lifetime, and the torque ratio.

The user may select “1” or “2” in the selection window D12. When the index selected by the button B11 to B15 is selected as the first index, the user selects “1” in the selection window D12. When the index selected by the button B11 to B15 is selected as the second index, the user selects “2” in the selection window D12.

When “1” is selected in the selection window D11, “2” is automatically selected in the selection window D12. When “2” is selected in the selection window D11, “1” is automatically selected in the selection window D12. When “1” is selected in the selection window D12, “2” is automatically selected in the selection window D11. When “2” is selected in the selection window D12, “1” is automatically selected in the selection window D11.

The CPU 610 determines the first index and the second index from the three or more indexes displayed in the user interface window I211 according to an instruction from the user. In the example of FIG. 10, the motion time is selected as the first index used for evaluation of the parameter set and the overshoot amount is selected as the second index used for evaluation of the parameter set. Accordingly, the motion time is determined as the first index and the overshoot amount is determined as the second index. The functional unit of the CPU 610 realizing the processing at step S205 is shown as “index determination unit 612a” in FIG. 6.

The above described processing is performed, and thereby, the parameter set that can realize performance reflecting an intention of the user may be presented to the user at the subsequent step S250.

At step S210 in FIG. 7, specific values of the parameter set to be evaluated are determined. In the embodiment, the parameter set to be evaluated is a combination of specific values of the limited maximum acceleration a0, the upper limit maximum acceleration a1, the gradient b of the reference target acceleration Ast, the gradient d of the load correction factor CL, and the servo gain Kpp, Kpi, Kpd, Kvp, Kvi, Kvd (see the middle left part in FIG. 2 and FIGS. 3 and 5). In the embodiment, at step S210, these specific values of the parameter set are determined by Bayesian optimization processing. Note that, when step S210 is first executed, values of the parameter set determined in advance and stored in the memory section 44 of the control apparatus 40 are employed. The functional unit of the CPU 610 realizing the processing at step S210 is shown as “new parameter determination unit 612b” in FIG. 6.

At step S220, the motion determined at step S200 is executed according to the parameter set determined at step S210. Then, the motion executed according to the parameter set determined at step S210 is evaluated. Specifically, values of a motion time OT as the first index and an overshoot amount OS as the second index when the robot 3 is moved using the parameter set for controlling the robot 3 determined at step S210 are acquired. The functional unit of the CPU 610 controlling the robot to execute the motion at step S220 is shown as “motion execution section 611” in FIG. 6. The functional unit of the CPU 610 evaluating the motion of the robot and acquiring the first index and the second index at step S220 is shown as “evaluation section 613” in FIG. 6. “Evaluation section 613” includes “motion time measuring unit 613a” and “overshoot amount measuring unit 613b”.

At step S230, the parameter set evaluated at the immediately preceding step S220 and the value of the first index and the value of the second index thereof are stored in the RAM 630. First, whether or not the parameter set evaluated at the immediately preceding step S220 is a Pareto solution is determined. When there is no parameter set better than the parameter set evaluated at the immediately preceding step S220 with respect to both the first index and the second index in the parameter sets determined at step S210 and evaluated at step S220 so far, the parameter set evaluated at the immediately preceding step S220 is “Pareto solution”. The parameter set evaluated at the immediately preceding step S220 is stored in the RAM 630 with information of a property of “being Pareto solution” or “not being Pareto solution”. Further, the properties of the parameter sets stored in the RAM 630 so far and worse than the parameter set newly stored in the RAM 630 with respect to both the first index and the second index are changed to “not being Pareto solution”.

At step S240, whether or not an end condition of optimization is satisfied is determined. Specifically, whether or not the processing at steps S210 to S230 is executed at a predetermined number of times is determined. In the embodiment, the predetermined number of times is three or more. When the processing at steps S210 to S230 is executed at the predetermined number of times, satisfactory of the end condition of optimization is determined. When the end condition of optimization is not satisfied, the count of times of repetition of the processing is increased and the processing returns to step S210. When the end condition of optimization is satisfied, the processing goes to step S250.

At step S210 executed subsequent to step S240, a new parameter set is acquired by Bayesian optimization based on the parameter sets determined at step S210 so far and the values of the first index and the values of the second index thereof. Then, at steps S220, S230, the value of the first index and the value of the second index when the robot 3 is moved using the new parameter set are acquired.

The processing at steps S210, S220, S230 is repeatedly executed until the condition of step S240 is satisfied. As a result, a plurality of parameter sets and values of the first index and values of the second index of the respective plurality of parameter sets are acquired. The functional unit of the CPU 610 realizing the processing at steps S210 to S240 using the new parameter determination unit 612b and the evaluation section 613 is shown as “parameter acquisition unit 612c” in FIG. 6. Further, the index determination unit 612a, the new parameter determination unit 612b, and the parameter acquisition unit 612c as the functional units of the CPU 610 are collectively shown as “parameter search section 612”.

At step S250 in FIG. 7, the CPU 610 performs display of the parameter sets stored in the RAM 630 based on the respective values of the first index and values of the second index on the display 602 (see the lower right part in FIG. 1).

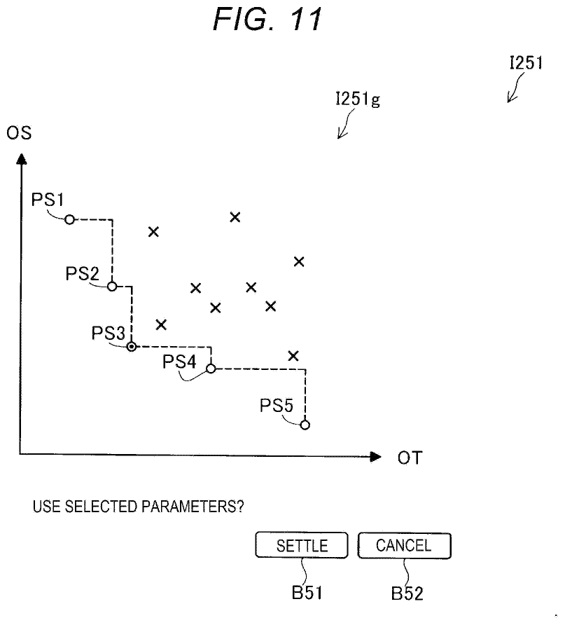

FIG. 11 shows a user interface window I251 shown at step S250. The user interface window I251 contains a graph I251g and buttons B51, B52.

The graph I251g is a graph with the motion time OT as the first index along a horizontal axis and the overshoot amount OS as the second index along a vertical axis. In the graph I251g, points corresponding to the parameter sets stored in the RAM 630 are plotted. The points showing the parameter sets not being Pareto solutions are shown by x. The points showing the parameter sets being Pareto solutions are shown by white circles. Broken lines parallel to the vertical axis or the horizontal axis connect the white circles showing the parameter sets being Pareto solutions.

In the graph I251g, the white circles showing the parameter sets PS1 to PS5 being Pareto solutions function as buttons. Only one of the buttons showing the parameter sets PS1 to PS5 being Pareto solutions may be selected.

The above described display is performed, and thereby, the user may select the parameter set that can realize the satisfactory values with respect to both the motion time OT as the first index and the overshoot amount OS as the second index from the plurality of parameter sets PS1 to PS5 according to the display of the circles based on the value of the motion time OT and the values of the overshoot amount OS of the plurality of parameter sets PS1 to PS5. Accordingly, the user who is hard to assume adequate numerical values in advance with respect to the value of the motion time OT and the value of overshoot amount OS may appropriately determine the parameter set.

That is, the user may easily understand the respective characteristics of the plurality of parameter sets based on the relative positions of the display in the graph I251g. Accordingly, the user may easily select the parameter set that can realize the satisfactory values with respect to both the motion time OT and the overshoot amount OS.

The display of the plurality of parameter sets PS1 to PS5 shown by the white circles in the graph I251g includes e.g. display showing the parameter set PS1 and display showing the parameter set PS5. The value of the motion time OT of the parameter set PS1 is smaller than the value of the motion time OT of the parameter set PS5. The value of the overshoot amount OS of the parameter set PS5 is smaller than the value of the overshoot amount OS of the parameter set PS1.

Accordingly, using the graph I251g, the user may select the parameter set by viewing the display of the parameter set PS1 that exerts the better performance with respect to the motion time OT and the parameter set PS5 that exerts the better performance with respect to the overshoot amount OS.

The parameter sets PS1 to PS5 shown by the white circles in the graph I251g include three or more parameter sets being Pareto solutions of the parameter sets stored in the RAM 630. That is, in the graph I251g on the display 602, display based on the other parameter sets PS2 to PS4 than the parameter set PS1 having the best value of the motion time OT and the parameter set PS5 having the best value of the overshoot amount OS is performed. Accordingly, the user may select the other parameter sets PS2 to PS4 than the parameter set PS1 having the best value of the motion time OT and the parameter set PS5 having the best value of the overshoot amount OS based on the display on the display 602. As a result, compared to a configuration in which display based on only the parameter set PS1 having the best value of the motion time OT and the parameter set PS5 having the best value of the overshoot amount OS is performed on the display 602, the user may be more likely to select the parameter set that can realize the satisfactory values with respect to both the motion time OT and the overshoot amount OS.

In the user interface window I251, the button B51 is a button for settling the parameter set selected by the white circle of the parameter sets PS1 to PS5 being Pareto solutions. The button B52 is a button for cancelling the parameter set selected by the white circle. The functional unit of the CPU 610 realizing the processing at step S250 is shown as “display control section 614” in FIG. 6.

At step S260 in FIG. 7, the CPU 610 receives an instruction to designate one parameter set of the plurality of parameter sets PS1 to PS5 from the user. Specifically, the user selects one of the white circles showing the parameter sets PS1 to PS5 in the graph I251g and clicks the button B51 with the mouse 605, and thereby, designates the parameter set. Then, the processing ends.

Then, the designated parameter set is transmitted from the setting apparatus 600 to the control apparatus 40 and stored in the memory section 44 (see FIG. 2). The robot 3 is controlled by the parameters 44a of the parameter set and the robot program 44b.

According to the configuration, the single parameter set reflecting an intention of the user may be determined as the parameter set used for control of the robot.

### (2) Method of Determining Parameter Set:

At step S210 in FIG. 7, a new parameter set is acquired by Bayesian optimization based on the parameter sets determined at step S210 so far and the values of the first index and the values of the second index thereof.

The Bayesian optimization is a method of searching for input x that maximizes output y on an assumption that a black box function providing the output y according to m-dimensional input x follows the Gaussian process (GP). Processing is performed on the assumption that the black box function follows the Gaussian process, and thereby, compared to a configuration on an assumption that an observation value of an objective function follows another distribution, optimization highly adapted to various objective functions may be performed by simple processing.

Objective function y=f(x): Black box function providing scalar value y (yϵR) determined by input x (xϵRm) as m-dimensional vector, m is an integer equal to or larger than 1.

In the embodiment, the m-dimensional input x is a parameter set as a combination of specific values of the limited maximum acceleration a0, the upper limit maximum acceleration a1, the gradient b of the reference target acceleration Ast, the gradient d of the load correction factor CL, and the servo gain Kpp, Kpi, Kpd, Kvp, Kvi, Kvd (see the middle left part in FIG. 2 and FIGS. 3 and 5).

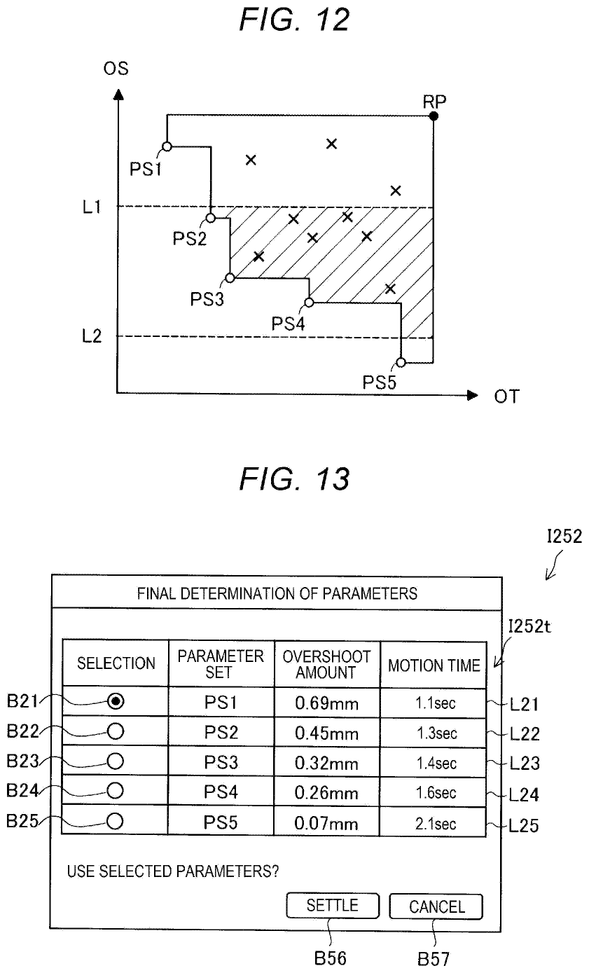

FIG. 12 shows an objective function space of Bayesian optimization at step S210 in FIG. 7. In the embodiment, the objective function space is a two-dimensional space with the motion time OT as the first index along a horizontal axis and the overshoot amount OS as the second index along a vertical axis. The objective function y=f(x) is a hypervolume of a part in which the overshoot amount OS is between L1 and L2 of a Pareto hypervolume determined by a reference point RP and the Pareto solutions obtained so far. L1 is an upper limit of the acceptable range of the overshoot amount. L2 is a lower limit of the acceptable range of the overshoot amount. L1, L2 are determined in advance and stored in the memory section 44 of the control apparatus 40 (see the lower left part in FIG. 2).

Optimization for obtaining x maximizing y is expressed by the following expression.

$$\begin{matrix}[ Math . 2 ] & \\ arg {max}_{x} y ( x ) & ( 1 )\end{matrix}$$

As output to be observed, output in a format with addition of observation noise ε is used.

Observation value of output yj=f(xj)+ε

A set of n outputs y for n sets of input x is a set of observation values (x1:n, y1:n).

It is assumed that value of the objective function f(x) follows the following Gaussian distribution.

Gaussian distribution determined by

$$\begin{matrix}[ Math . 3 ] & \\ N ( {μ}_{n} ( \hat{x} ) , {σ}_{n}^{2} ( \hat{x} ) ) & \end{matrix}$$

an average estimated value for unobserved input x obtained as a result of n sets of observation

$$\begin{matrix}[ Math . 4 ] & \\ {μ}_{n} ( \hat{x} ) & \end{matrix}$$

and an estimated value of variance

$$\begin{matrix}[ Math . 5 ] & \\ {σ}_{n}^{2} ( \hat{x} ) & \\ [ Math . 6 ] & \\ {μ}_{n} ( \hat{x} ) = {μ}_{0} + {k}^{T} ( \hat{x} , {x}_{1 : n} ) {( K + {σ}^{2} I )}^{- 1} {y}_{1 : n} & ( 2 ) \\ [ Math . 7 ] & \\ {σ}_{n}^{2} ( \hat{x} ) = k ( \hat{x} , \hat{x} ) - {k}^{T} ( \hat{x} , {x}_{1 : n} ) {( K + {σ}^{2} I )}^{- 1} k ( \hat{x} , {x}_{1 : n} ) & ( 3 )\end{matrix}$$

where
example of kernel function:

$$k ( {x}_{i} , {x}_{j} ) = α \cdot exp ( - \frac{1}{2} Λ {‖ {x}_{i} - {x}_{j} ‖}^{2} ) + β \qquad$$

kernel matrix:

$$K = [ \begin{matrix}k ( {x}_{1 ,} {x}_{1} ) & … & k ( {x}_{1 ,} {x}_{n} ) \\ ⋮ & ⋱ & ⋮ \\ k ( {x}_{n ,} {x}_{1} ) & … & k ( {x}_{n ,} {x}_{n} )\end{matrix} ]$$

covariance vector k(\hat{x}, x_{1:n}): covariance vector between unobserved input \hat{x} and a series of input x_{1:n} σ² expresses: variance of noise t, I expresses identity matrix and superscript ^{T} expresses transposition α, Λ, β of kernel function k(xᵢ,xⱼ) are hyperparameters adjusted to adapt Gaussian process to observation results in procedures of Bayesian optimization

Though not essential, the hyperparameters may be adjusted to further fit the Gaussian process to the observation result.

The acquired function (AF) is a function expressing an evaluation value for the unobserved input x. The input x having the highest acquired function is selected as the next input. As the, acquired function, e.g. the following function AF1(x) or AF2(x) may be used.

EI function (Expected Improvement):

$$\begin{matrix}[ Math . 8 ] & \\ {AF}_{1} ( x ) = EI ( x ) = ( {μ}_{n} ( x ) - f ( {x}_{best} ) ) Φ ( Z ) + {σ}_{n} ( x ) ϕ ( Z ) & ( 4 ) \\ Z = ( {μ}_{n} ( x ) - f ( {x}_{best} ) ) / {σ}_{n} ( x ) & \end{matrix}$$

where ϕ expresses a standard normal distribution, Φ expresses a standard normal cumulative distribution, and x_{best} is an input value with the best value of output y of observed values
   Confidence bound (CB):

$$\begin{matrix}[ Math . 9 ] & \\ {AF}_{2} ( x ) = CB ( x ) = {μ}_{n} ( x ) \pm λ {σ}_{n} ( x ) & ( 5 ) \\ where λ is a coefficient & \end{matrix}$$

Regarding “±” on the right side of the expression (5), when “+” is used, the expression is the acquired function by “upper confidence bound (UCB)” and, when “−” is used, the expression is the acquired function by “lower confidence bound (LCB)”.

At step S210 in FIG. 7, the input x maximizing the acquired function AF(x) (see expression (4) and expression (5)) is obtained. The obtained x is used as the next input xi+1.

The above described processing is performed, and thereby, a plurality of parameter sets that may increase the hypervolume of the part in which the overshoot amount OS is between L1 and L2 of the Pareto hypervolume determined by the reference point RP and the Pareto solutions shown in FIG. 12 to a degree close to a case where a plurality of parameter sets as theoretical optimal solutions are obtained may be efficiently obtained.

The setting apparatus 600 in the embodiment is, also referred to as “information processing apparatus”. The parameter set PS1 is also referred to as “first parameter set”. The parameter set PS5 is also referred to as “second parameter set”. The processing at step S220 to be first executed is also referred to as “first evaluation processing”. The processing at step 3220 to be executed after the processing at step S240 is also referred to as “second evaluation processing”. The evaluation section 613 first executing the processing at step S220 is also referred to as “first evaluation unit”. The evaluation section 613 executing the processing at step S220 after the processing at step S240 is also referred to as “second evaluation unit”. The processing at step S250 is also referred to as “display processing”.

### B. Embodiment 2

In Embodiment 2, the format of display at step S250 in FIG. 7 is different from that of Embodiment 1 (see FIG. 11). The rest of Embodiment 2 is the same as that of Embodiment 1.

FIG. 13 shows a user interface window I252 shown at step S250 in FIG. 7. The user interface window I252 includes a list I252t and buttons B21 to B25, B56, B57.

At step S250 of Embodiment 2, the list I252t containing items L21 to L25 respectively corresponding to the plurality of parameter sets PS1 to PS5 being Pareto solutions is displayed. The list I252t does not contain items corresponding to the parameter sets not being Pareto solutions (see x in FIG. 11).

The items L21 to L25 corresponding to the parameter sets PS1 to PS5 respectively contain the values of the motion time OT as the first index and the values of the overshoot amount OS as the second index. In the list I252t, the respective items L21 to L25 are arranged in the order of the values of the motion time OT. In the example of FIG. 13, the respective items L21 to L25 are arranged from the top to the bottom in ascending order of the values of the motion time OT, that is, the upper value of the motion time OT is better.

According to the display format, the user may easily select the parameter set from the parameter sets PS1 to PS5 based on the display positions of the respective items L21 to L25 in the list I252t.

The numerals contained in the PS1 to PS5 displayed on the second column from the left of the respective items L21 to L25 show the ranking of the motion time OT. The parameter set having the best motion time OT is displayed as PS1. The parameter set having the worst motion time OT is displayed as PS5. That is, in the list I252t, the items L21 to L25 containing the ranking of the first index of the respective parameter sets PS1 to PS5 are shown.

The buttons B21 to B25 are buttons for selection of the parameter set being the Pareto solution. Only one of the buttons B21 to B25 may be selected.

The button B56 is a button for settling the parameter set selected by the button B21 to B25 of the parameter sets PS1 to PS5 being Pareto solutions. The button B57 is a button for cancelling the parameter set selected by the button B21 to B25.

According to the display format, the user may select the parameter set from the parameter sets PS1 to PS5 with reference to the ranking of the index in the list.

### C. Embodiment 3

In Embodiment 3, the format of display at step S250 in FIG. 7 is different from that of Embodiment 1 (see FIG. 11). The rest of Embodiment 3 is the same as that of Embodiment 1.

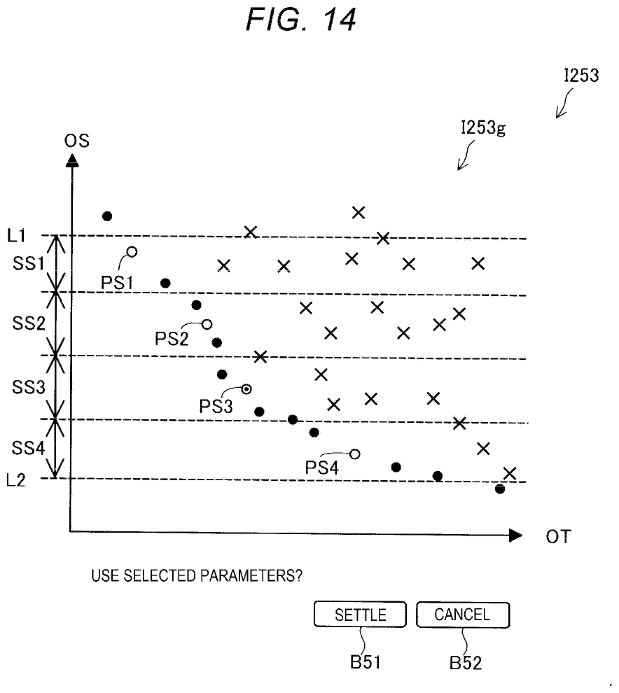

FIG. 14 shows a user interface window I253 shown at step S250 in FIG. 7. The user interface window I253 contains a graph I253g and buttons B51, B52.

The functions of the buttons B51, B52 are the same as those of the buttons B51, B52 of the user interface window I251 in Embodiment 1, respectively (see FIG. 11).

In the graph I253g, points showing the parameter sets stored in the RAM 630 are displayed. The points showing the parameter sets not being Pareto solutions are shown by x. One part of the points showing the parameter sets being Pareto solutions are shown by white circles. The other part of the points showing the parameter sets being Pareto solutions are shown by black circles.

In the graph I253g, the plurality of parameter sets PS1 to PS4 shown by the white circles are parameter sets being Pareto solutions respectively selected for each of a plurality of sections SS1 to SS4 provided within the acceptable range of the overshoot amount OS as the second index of the parameter sets being Pareto solutions. In the graph I253g, the parameter sets shown by the black circles are parameter sets being Pareto solutions not selected with respect to the sections SS1 to SS4 of the parameter sets being Pareto solutions. The sections SS1 to SS4 are continuous sections provided in the same width within the acceptable range of the overshoot amount OS as the second index. In the embodiment, the selected parameter sets PS1 to PS4 are parameter sets having the overshoot amounts OS closest to intermediate values of the sections in the respective sections SS1 to SS4. The other points in the graph I253g are the same as those in the graph I251g.

According to the display format, with respect to the overshoot amount OS as the second index, the representative parameter sets PS1 to PS4 are distinguished from the parameter sets as the other Pareto solutions and presented to the user. Accordingly, compared to a format in which all display corresponding to the plurality of parameter sets being Pareto solutions is performed on the display 602 without distinction, display on the display 602 may be easily understood. Therefore, the user may easily select control parameters based on the display on the display 602.

### D. Embodiment 4

In embodiment 4, the format of display at step S250 in FIG. 7 is different from that of Embodiment 2 (see FIG. 13). The rest of Embodiment 4 is the same as that of Embodiment 2.

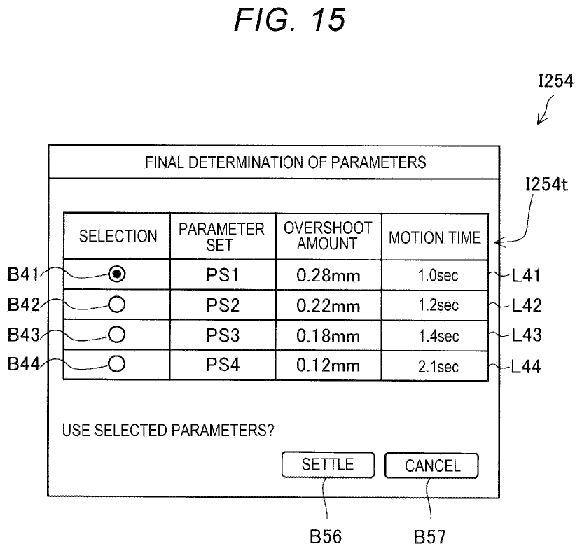

FIG. 15 shows a user interface window I254 shown at step S250 in FIG. 7. The user interface window I254 includes a list I254t and buttons B41 to B44, B56, B57.

The functions of the buttons B56, B57 are the same as the buttons B56, B57 of the user interface window I252 in Embodiment 2, respectively (see FIG. 13).

At step S250 of Embodiment 4, the list I254t containing items L41 to L44 respectively corresponding to the plurality of parameter sets PS1 to PS4 being Pareto solutions is displayed. The list I254t does not contain items corresponding to the parameter sets not being Pareto solutions.

The parameter sets PS1 to PS4 corresponding to the items L41 to L44 displayed in the list I254t are parameter sets respectively selected for each of the plurality of sections SS1 to SS4 provided with respect to the overshoot amount OS as the second index. In the embodiment, the parameter sets PS1 to PS4 are parameter sets having the overshoot amounts OS closest to intermediate values of the sections in the sections SS1 to SS4 (see FIG. 14). The list I254t does not contain items corresponding to the parameter sets being Pareto solutions not selected with respect to the sections SS1 to SS4 of the parameter sets being Pareto solutions. The rest of the list I254t is the same as that of the list I252t.

According to the display format, with respect to the overshoot amount OS as the second index, the representative parameter sets are presented to the user. Accordingly, compared to a format in which all display corresponding to the plurality of parameter sets is performed on the display 602, display on the display 602 may be simpler. Therefore, the user may easily select control parameters based on the display on the display 602.

### E. Embodiment 5

In Embodiment 5, processing at S250 and subsequent steps in FIG. 7 is different from that of Embodiment 1. The rest of Embodiment 5 is the same as that of Embodiment 1.

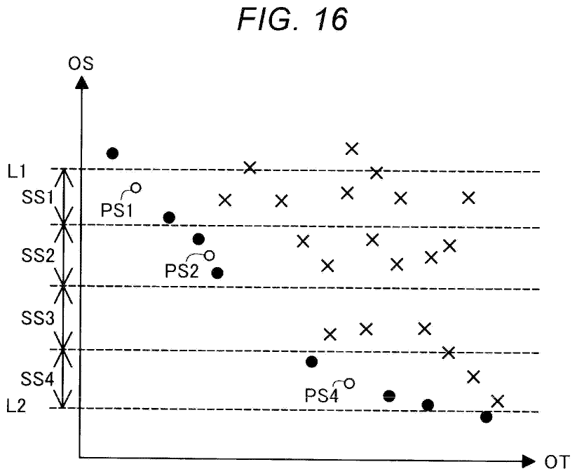

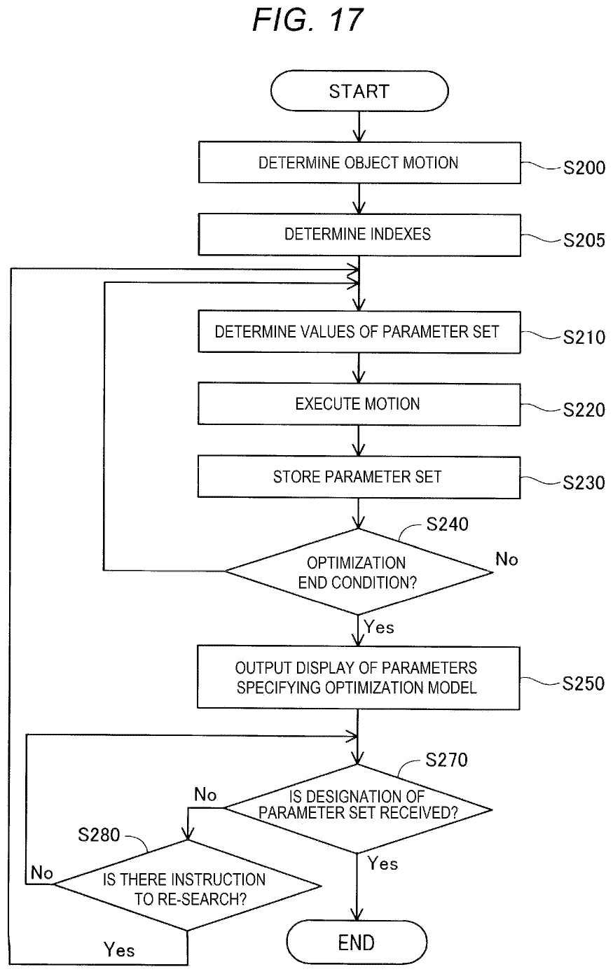

FIG. 16 is a graph showing characteristics of parameter sets obtained in the processing to step S240. In the graph shown in FIG. 16, points showing the parameter sets stored in the RAM 630 are displayed. The points showing the parameter sets not being Pareto solutions are shown by x. With respect to the sections SS1 to SS4, the parameter sets being Pareto solutions respectively selected for each are shown by white circles. The points showing the parameter sets being other Pareto solutions are shown by black circles. As shown in FIG. 17, the parameter sets obtained in the processing to step S240 do not contain the Pareto solutions in the section SS3.

FIG. 17 is a flowchart showing processing of optimizing parameters of the robot in Embodiment 5. The processing at steps S200 to S240 in FIG. 16 is the same as the processing at steps S200 to S240 in FIG. 7 in Embodiment 1.

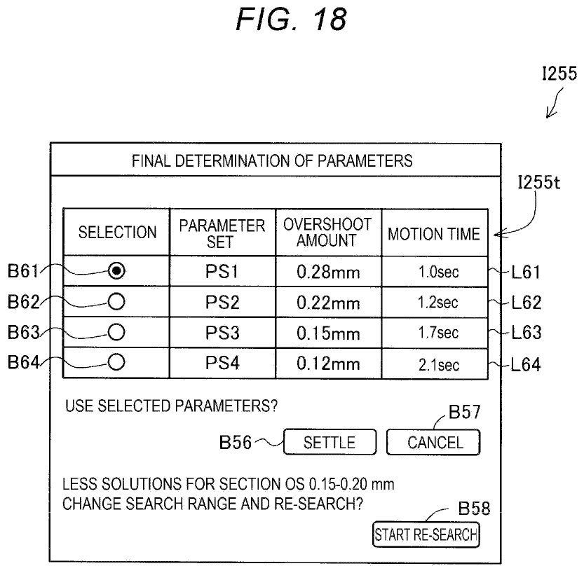

FIG. 18 shows a user interface window I255 shown at step S250 in FIG. 17. The user interface window I255 includes a list I255t and buttons B61 to B64, B56 to B58. The list I255t contains items L61 to L64 respectively corresponding to the plurality of parameter sets PS1 to PS4 being Pareto solutions. The configurations of the items L61 to L64 are the same as those of the items L21 to L25 in the list I252t shown in FIG. 13. The functions of the buttons B61 to B64 are the same as the buttons B21 to B25 of the user interface window I252. The functions of the buttons B56, B57 are the same as the buttons B56, B57 of the user interface window I252.

In the user interface window I255 of Embodiment 5, when there is a section not containing a Pareto solution in the predetermined sections with respect to the second index, a message “Less solutions for OS XX mm to XX mm Change search range and re-search?” is displayed with the button B58 (see the lower part in FIG. 18). When there is no section not containing a Pareto solution in the predetermined sections with respect to the second index, the message and the button B58 are not displayed.

When wishing to re-search the section with less solutions, the user presses the button B58 and instructs re-search. On the other hand, when selecting the parameter set from the displayed parameter sets PS1 to PS4, the user selects one of the buttons B61 to B64 and presses the button B56.

At step S270 in FIG. 17, the CPU 610 determines whether or not to receive an instruction to designate one parameter set of the plurality of parameter sets presented on the user interface window I255 from the user within a predetermined time. When the determination result is Yes, the processing ends. Then, the designated parameter set is transmitted from the setting apparatus 600 to the control apparatus 40 and stored in the memory section 44 (see FIG. 2). On the other hand, when the determination result is No, the processing goes to step S280.

At step S280, the CPU 610 determines whether or not to receive an instruction of re-search from the user within a predetermined time (see B58 in FIG. 18). When the determination result is No, the processing returns to step S270. When the determination result is Yes, the processing returns to step S210.

When executed after the processing at step S280, steps S210, S220 are repeatedly executed with respect to the overshoot amount OS as the second index in a smaller range than that of the processing at steps S210, S220 performed before the processing at the immediately preceding step S280. Specifically, with respect to the section of the second index with no Pareto solution, the processing at steps S210 to S230 is repeatedly executed. As a result, the plurality of parameter sets and the values of the motion time OT and the values of the overshoot amount OS of the respective plurality of parameter sets are acquired. The functional unit of the CPU 610 realizing the processing at steps S210 to S240 through step S280 is shown by broken lines as “re-search unit 612d” in FIG. 6.

The subsequent processing is as described above. For example, at step S250, display is performed on the display 602 based on the obtained plurality of parameter sets and the values of the motion time OT and the values of the overshoot amount OS of the respective plurality of parameter sets (see FIG. 18 and FIG. 13).

The above described processing is performed, and thereby, the user may view the display based on the values of the motion time OT and the values of the overshoot amount OS of the respective plurality of parameter sets at step S205, then, when the values do not fulfill the user's wishes, re-search the parameter set that further fulfills the user's wishes (see FIG. 17).

### F. Embodiment 6

In Embodiment 6, in the robot 3, as sensors, an acceleration sensor S2 and a microphone S3 are provided in addition to the acceleration sensor S1 at the distal end of the arm member A6. Further, in Embodiment 6, the details of the processing at steps S205, S210, S230 in FIG. 7 are different from those of Embodiment 1. The rest of Embodiment 6 is the same as that of Embodiment 1.

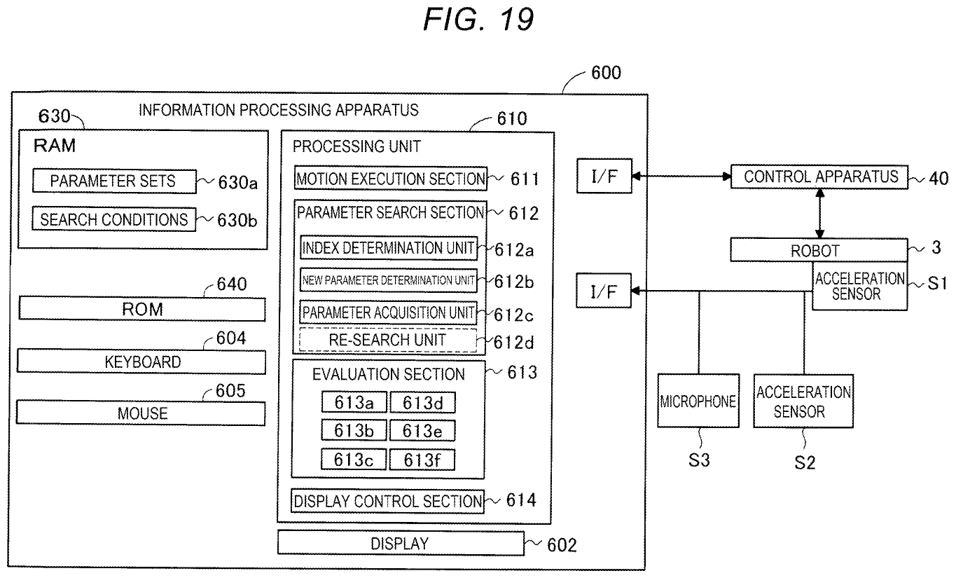

FIG. 19 is a block diagram showing configurations of the setting apparatus 600 and the robot 3 in Embodiment 6. In Embodiment 6, the acceleration sensor S2 and the microphone S3 are provided in the base T of the robot 3. The function of the acceleration sensor S2 is the same as the acceleration sensor S1. The control apparatus 40 may measure vibration of the base T of the robot 3 based on information obtained from the acceleration sensor S2 (see FIG. 8). The microphone S3 may collect sound around. The control apparatus 40 may measure a noise level around the robot 3 based on information obtained from the microphone S3 (see FIG. 9). As a result, in Embodiment 6, a vibration amount of the base T of the robot 3 and the noise level around the base T of the robot 3 may be selected as the first index or the second index.

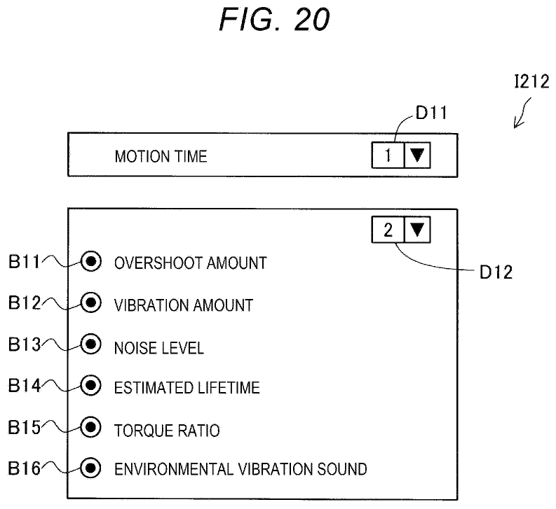

FIG. 20 shows a user interface window I212 displayed on the display 602 of the setting apparatus 600 at step S205 in FIG. 7. The user interface window I212 contains buttons B11 to B16 and selection windows D11, D12. The button B16 is a button for selection of “environmental vibration amount” as the vibration amount of the base T of the robot 3 as an index for evaluation of control. The functions of the buttons B11 to B15 are the same as those of the buttons B11 to B15 in the user interface window I211 of Embodiment 1, respectively.

Note that, in Embodiment 6, the buttons B11 to B16 are configured so that two or more thereof can be selected at the same time. In Embodiment 6, all of the buttons B11 to B16 are selected in the initial state. The user may select any of the overshoot amount, the vibration amount, the noise level, the estimated lifetime, the torque ratio, and the environmental vibration amount or cancel the selection by turning on or off the buttons B11 to B16 in the user interface window I212.

The functions of the selection windows D11, D12 are the same as the functions of the selection windows D11, D12 in the user interface window I211 in Embodiment 1, respectively (see FIG. 10).

In the embodiment, the objective function space in the processing at step S210 in FIG. 7 is a multidimensional space of the motion time OT and one or more indexes selected by the buttons B11 to B15. The objective function y=f(x) is a hypervolume of a part in which the overshoot amount OS is between L1 and L2 of the Pareto hypervolume determined by the reference point RP and the Pareto solutions obtained so far (see FIG. 12). The above described processing is performed, and thereby, at step S210 in FIG. 7, optimization processing may be performed with respect to three or more indexes and the next parameter set may be determined.

The processing at step S220 in FIG. 7 is the same as the processing at step S220 in Embodiment 1. Note that measurements are performed with respect to all indexes selected by the buttons B11 to B16 in the user interface window I212 (see FIG. 20).

At step S230, all of the parameter sets evaluated at the immediately preceding step S220 and the values of the first index and the values of the second index are stored in the RAM 630.

The processing at step S250 is the same as the processing at step S250 in Embodiment 1. Note that the Pareto solutions displayed on the display 602 of the setting apparatus 600 are parameter sets obtained by optimization processing with respect to all indexes selected by the buttons B11 to B16 (see FIG. 11). The above described processing is performed, and thereby, the user may select the optimized parameter sets with respect to three or more indexes.

### G. Other Embodiments

### G1. Other Embodiment 1

(1) In the above described embodiments, the optimization of the motion parameters 44c is explained using the example of picking up the object W using the gripper 23 of the robot 3 (see FIGS. 1 and 3). However, the processing of optimizing the parameters is not limited to the motion parameters 44c in pickup processing, but can be applied to other various kinds of processing. For example, the processing of optimizing the parameters can be applied to processing of placing the imaging unit 21 or processing of placing the illumination unit 22. Further, the processing of optimizing the parameters can be applied to screwing, insertion, drilling, deburring, polishing, assembly, product checking, or the like.

(2) In this specification, in the explanation of the details of techniques, “plurality of sets of input parameters” are mentioned for convenience. However, “plurality of sets of input parameters” in this specification include input parameters for estimation of averages and distributions of constrained functions and objective functions as continuous values.

(3) In the above described embodiments, the motion parameters 44c to be optimized include the limited maximum acceleration a0, the upper limit maximum acceleration a1, the gradient b of the reference target acceleration Ast, and the gradient d of the load correction factor CL (see FIGS. 4 and 5). However, the motion parameters 44c to be optimized may be other motion parameters 44c, e.g. parameters expressing the start point and the end point of motion, parameters expressing the servo gain, and parameters such as optical parameters and force control parameters (see FIG. 3).

(4) In the above described embodiments, the parameters to be optimized are parameters for controlling motion of a vertical articulated robot (see FIGS. 1 and 3). However, the parameters to be optimized may be parameters for controlling motion of another robot such as a horizontal articulated robot or a Cartesian coordinate robot. For example, the parameters to be optimized may be parameters for controlling motion of a robot including seven or more operation axes or motion of a multi-arm robot such as a dual-arm robot. Generally, loads in the robot including seven or more operation axes and the multi-arm robot are higher than the other robots. Accordingly, for optimization of the parameters for controlling motion of the robot, it is desirable that the objective function contains “drive force necessary for motion of the robot”.

(5) In the above described embodiment 1, the optimization processing is performed using the hypervolume of the part in which the overshoot amount OS as the second index is between L1 and L2 of the Pareto hypervolume determined by the reference point RP and the Pareto solutions obtained so far as the objective function. However, L1, L2 defining the objective function may be determined with respect to the first index. Or, without determination of those L1, L2, the entire Pareto hypervolume determined by the reference point RP and the Pareto solutions obtained so far may be used as the objective function.

(6) In the above described embodiment 1, the optimization processing is performed using the hypervolume of the part in which the overshoot amount OS as the second index is between L1 and L2 of the Pareto hypervolume determined by the reference point RP and the Pareto solutions obtained so far as the objective function. However, the objective function of the optimization processing may be another function containing the first index and the second index, e.g. the maximum value of the distances from the reference point to the respective solutions in the objective function space.

(7) In the above described embodiments, the optimization is performed on the assumption that the unobserved output of the objective function and the unobserved output of the constrained function for certain input each follow the Gaussian distribution. However, the estimation that the output of the objective function and the output of the constrained function follow a statistical distribution may be performed using another statistical distribution than the Gaussian distribution such as a triangular distribution, a gamma distribution, or a Weibull distribution. Or, processing may be performed based on the estimation that the output of the objective function and the output of the constrained function follow statistical distributions different from each other.

Note that, in this specification, “statistical distribution” refers to a distribution that may define a whole using a finite number of statistical parameters.

(8) In Embodiment 6, the objective function space is a multidimensional space of the motion time OT and one or more indexes selected by the buttons B11 to B15. The objective function y=f(x) is the hypervolume of the part in which the overshoot amount OS is between L1 and L2 of Pareto hypervolume determined by the reference point RP and the Pareto solutions obtained so far (see FIGS. 12 and 20). However, when optimization is performed with respect to three or more indexes, one or more indexes are contained as penalty functions in the objective function, and thereby, the indexes may be considered.

(9) In the above described embodiments, the optimization of the input parameters with respect to the objective function is performed by Bayesian optimization (see S210 in FIG. 7 and FIG. 12). However, the multi-objective optimization technique of the input parameters with respect to a plurality of indexes may be performed by another optimization algorithm such as NSGA-II (Non dominated-Sorting Genetic Algorithm-II) or NSGA-III (Non dominated-Sorting Genetic Algorithm-III).

(10) In the above described embodiments, at step S220, the robot 3 is actually moved using the parameter set and the values of the first index and the second index are measured (see FIGS. 7 and 17). However, a simulation may be performed using a simulator that can reproduce residual vibration of the robot and an evaluation of control using the parameter set may be performed.

(11) In the above described embodiment 2, the list I252t containing the items L21 to L25 respectively corresponding to the plurality of parameter sets PS1 to PS5 being Pareto solutions is displayed. In the list I252t, the respective items L21 to L25 are arranged from the top to the bottom in the order of the better value of the motion time OT (see FIG. 13). However, in the list, the respective items may be displayed from the bottom to the top in the order of the better value of the first index. Or, the respective items may be displayed from the top to the bottom or from the bottom to the top in the order of the better value of the second index.

(12) In the above described embodiment 6, the processing at step S250 is the same as the processing at step S250 in Embodiment 1. That is, the user interface window I251 containing the graph I251g is displayed on the display 602 (see FIG. 11). However, in the above described embodiment 6, the vertical axis and the horizontal axis of the displayed graph may be determined according to an instruction by the user.

(13) In the above described embodiments, in the processing at step S250, the graph or the list is displayed (see FIGS. 11, 13 to 15, and 18). However, in the processing at step S250, both the graph and the list may be displayed at the same time or switched and displayed. Or, a user interface that may exchange the vertical axis and the horizontal axis of the graph may be provided.

(14) In the above described embodiment 5, with respect to the overshoot amount OS as the second index, the processing at steps S210, S220 executed after reception of the instruction of re-search is repeatedly executed for the smaller range than that for the processing at steps S210, S220 performed before the processing at the immediately preceding step S280 (see FIG. 17). However, the re-search may be performed in a smaller range of the second index.

(15) In the above described embodiment 5, with respect to the overshoot amount OS as the second index, the processing at steps S210, S220 executed after reception of the instruction of re-search is repeatedly executed for the smaller range than that for the processing at steps S210, S220 performed before the processing at the immediately preceding step S280 (see FIG. 17). Specifically, with respect to the section with no Pareto solution, the processing at steps S210 to S230 is repeatedly executed (see FIG. 14). However, the re-search range may be designated by the user.

### G2. Other Embodiment 2

In the above described embodiment 1, at step S260 in FIG. 7, the CPU 610 receives the instruction to designate one parameter set of the plurality of parameter sets PS1 to PS5 from the user. However, when there is no instruction from the user in a predetermined time, the CPU 610 may select and transmit one of the parameter sets being Pareto solutions to the control apparatus 40.

### G3. Other Embodiment 3

In the above described embodiment 1, in the user interface window I211, three or more indexes for evaluation of the control result of the robot 3 are displayed on the display 602 (see FIG. 10). However, two indexes, e.g. the motion time and the overshoot amount may be displayed on the display unit.

### G4. Other Embodiment 4

In the above described embodiment 1, the value of the motion time OT of the parameter set PS1 is smaller than the value of the motion time OT of the parameter set PS5. The value of the overshoot amount OS of the parameter set PS5 is smaller than the value of the overshoot amount OS of the parameter set PS1 (see FIG. 11). However, when display based on the values of the first index and the values of the second index is performed on the display unit with respect to two or more parameter sets, a plurality of parameter sets containing parameter sets having the same one of the value of the first index and the value of the second index may be displayed.

### G5. Other Embodiment 5

In the above described embodiment 1, the graph I251g with the motion time OT as the first index along the horizontal axis and the overshoot amount OS as the second index along the vertical axis is displayed on the display 602. However, a table may be shown like Embodiments 2, 4, 5 (see FIGS. 13, 15, and 18). Or, the values of the first index and the values of the second index may be displayed, not in the format of the table, but in a format of a list without a frame with respect to the respective parameter sets.

### G6. Other Embodiment 6

In the above described embodiment 2, the list I252t containing the items L21 to L25 respectively corresponding to the plurality of parameter sets PS1 to PS5 being Pareto solutions is displayed. In the list I252t, the respective items L21 to L25 are arranged in the order of the better value of the motion time OT (see FIG. 13). However, the respective items may be arranged and displayed according to another criterion such as a distance from the origin in a space defined by two axes of the first index and the second index or a distance from the reference point RP. Or, a graph may be shown like embodiments 1, 3 (see FIGS. 11 and 14).

### G7. Other Embodiment 7

In the list I252t of the above described embodiment 2, the numerals contained in the PS1 to PS5 displayed on the second column from the left of the respective items L21 to L25 show the ranking of the motion time OT (see FIG. 13). However, the displayed list may not necessarily contain the above described ranking.

### G8. Other Embodiment 8

In the above described embodiment 3, in the graph I253g, the plurality of parameter sets PS1 to PS4 shown by the white circles are parameter sets being Pareto solutions respectively selected for each of the plurality of sections SS1 to SS4 provided in the same width within the acceptable range of the overshoot amount OS as the second index of the parameter sets being Pareto solutions. However, in a graph or a list, display corresponding to the parameter sets as all Pareto solutions may be shown.

### G9. Other Embodiment 9

In the above described embodiment 5, with respect to the overshoot amount OS, the processing at steps S210, S220 executed after reception of the instruction of re-search is repeatedly executed for the smaller range than that for the processing at steps S210, S220 performed before the processing at the immediately preceding step S280 (see FIG. 17). However, a configuration not receiving the re-search instruction like Embodiments 1 to 4 (see FIG. 7) may be employed.

### G10. Other Embodiment 10

In the above described embodiment 5, at step S240, whether or not the processing at steps S210 to S230 is executed at the predetermined number of times is determined. In Embodiment 1, the predetermined number of times is three or more (see FIG. 7). The parameter sets PS1 to PS5 shown by the white circles in the graph I251g include three or more parameter sets being Pareto solutions of the parameter sets stored in the RAM 630. However, the number of parameter sets determined in the processing at steps S210 to S230 may be two. Or, the number of parameter sets determined in the processing at steps S210 to S230 may be another number, e.g. five, ten, or a hundred. The threshold value of the number of times of repetition for determination at step S240 may be determined according to the number of parameter sets to be obtained.

For example, when a re-search is performed in a limited range of the second index, only one solution parameter set minimizing the first index obtained as a result of the re-search may be shown (see S280 in FIG. 17). Similarly, when a re-search is performed in a limited range of the first index, only one solution parameter set minimizing the second index obtained as a result of the re-search may be shown.

### H. Yet Other Embodiments

The present disclosure is not limited to the above described embodiments, but may be realized in various aspects without departing from the scope thereof. For example, the present disclosure can be realized in the following aspects. The technical features in the above described embodiments corresponding to the technical features in the following respective aspects can be appropriately replaced or combined in order to solve part or all of the problems of the present disclosure or achieve part or all of the effects of the present disclosure. Further, the technical features not described as essential features in this specification can be appropriately deleted.

(1) According to an aspect of the present disclosure, a method of performing display with respect to parameters of a robot is provided. The method includes (a) determining a first index and a second index for evaluation of a control result of the robot, (b) acquiring a value of the first index and a value of the second index when the robot is moved using a parameter set for control of the robot, (c) determining a new parameter set using a multi-objective optimization technique with a function containing the first index and the second index as an objective function based on the parameter set and the acquired value of the first index and value of the second index, (d) acquiring the value of the first index and the value of the second index when the robot is moved using the new parameter set, (e) acquiring a plurality of parameter sets and values of the first index and values of the second index of the respective plurality of parameter sets by repeatedly executing (c) and (d), and (f) performing display based on the respective values of the first index and values of the second index with respect to two or more parameter sets of the plurality of parameter sets on a display unit, the two or more parameter sets including a first parameter set and a second parameter set, and the first parameter set and the second parameter set satisfying at least one of conditions that the value of the first index of the first parameter set is better than the value of the first index of the second parameter set, and the value of the second index of the second parameter set is better than the value of the second index of the first parameter set.

According to the configuration, the user may select the parameter set that can realize satisfactory values with respect to both the first index and the second index from the two or more parameter sets based on the display of the values of the first index and the values of the second index of the two or more parameter sets.

(2) The method may further include (g) receiving an instruction to designate one parameter set of the two or more parameter sets from a user.

According to the configuration, the single parameter set reflecting an intention of the user may be determined.

(3) In the method, (a) may include displaying three or more indexes for evaluation of the control result of the robot on the display unit, and determining the first index and the second index from the three or more indexes according to an instruction from a user.

According to the configuration, the parameter set that can realize performance reflecting an intention of the user may be presented to the user at (f).

(4) In the method, the value of the first index of the first parameter set may be better than the value of the first index of the second parameter set, and the value of the second index of the second parameter set may be better than the value of the second index of the first parameter set.

According to the configuration, the user may select the parameter set by viewing the display based on the parameter set that exerts the better performance with respect to the first index and the parameter set that exerts the better performance with respect to the second index.

(5) In the method, (f) may include displaying a graph on the display unit based on the values of the first index and the values of the second index of the two or more parameter sets.

According to the configuration, the user may easily understand the respective characteristics of the two or more parameter sets based on the display of the graph. Accordingly, the user may easily select the parameter set that can realize satisfactory values with respect to both the first index and the second index from the two or more parameter sets.

(6) In the method, (f) may include displaying a list containing items respectively corresponding to the two or more parameter sets and containing the values of the first index and the values of the second index, and the respective items are arranged in an order of the values of the first index or the values of the second index.

According to the configuration, the user may easily select the parameter set from the two or more parameter sets based on the display positions of the respective items in the list.

(7) In the method, the respective items may include at least one of a ranking of the first index of the respective two or more parameter sets and a ranking of the second index of the respective two or more parameter sets.

According to the configuration, the user may easily select the parameter set from the two or more parameter sets with reference to the ranking of the index in the list.

(8) In the method, the two or more parameter sets may include parameter sets being Pareto solutions respectively selected for each of a plurality of sections provided for the first index or parameter sets being Pareto solutions respectively selected for each of a plurality of sections provided for the second index.

According to the configuration, with respect to the first index or the second index, the representative parameter sets are presented to the user. Accordingly, compared to a configuration in which all display corresponding to the plurality of parameter sets is performed on the display unit, display on the display unit may be simpler. Therefore, the user may easily select the parameters based on the display on the display unit.

(9) The method may further include, (h), after (f), acquiring a plurality of parameter sets and values of the first index and values of the second index of the respective plurality of parameter sets by repeatedly executing (c) and (d) for a smaller range than that for the processing at steps (c) and (d) performed so far with respect to at least one of the first index and the second index of the parameter set according to an instruction of a re-search from a user, and (i) executing (f) with respect to the plurality of parameter sets obtained at (h).

According to the configuration, after viewing display based on the values of the first index and the values of the second index of the two or more parameter sets at (f), the user may search for a parameter set that further fulfills the user's wishes.

(10) In the method, the two or more parameter sets may include three or more parameter sets being Pareto solutions of the plurality of parameter sets.

In the configuration, the display based on the other parameter sets than the parameter set having the best value of the first index and the parameter set having the best value of the second index is performed on the display unit. Accordingly, the user may select the other parameter set than the parameter set having the best value of the first index and the parameter set having the best value of the second index based on the display on the display unit. Accordingly, compared to a configuration in which display based on only the parameter set having the best value of the first index and the parameter set having the best value of the second index is performed on the display unit, the user may be more likely to select the parameter set that can realize the satisfactory values with respect to both the first index and the second index.

(11) According to another aspect of the present disclosure, a program for controlling a computer to perform display with respect to parameters of a robot is provided. The program controls the computer to realize a first function of determining a first index and a second index for evaluation of a control result of the robot, a second function of acquiring a value of the first index and a value of the second index when the robot is moved using a parameter set for control of the robot, a third function of determining a new parameter set using a multi-objective optimization technique with a function containing the first index and the second index as an objective function based on the parameter set and the acquired value of the first index and value of the second index, a fourth function of acquiring the value of the first index and the value of the second index when the robot is moved using the new parameter set, a fifth function of acquiring a plurality of parameter sets and values of the first index and values of the second index of the respective plurality of parameter sets by repeatedly executing the function of determining the new parameter set and the function of acquiring the value of the first index and the value of the second index, and a sixth function of performing display based on the respective values of the first index and values of the second index with respect to two or more parameter sets of the plurality of parameter sets on a display unit, the two or more parameter sets including a first parameter set and a second parameter set, and the first parameter set and the second parameter set satisfying at least one of conditions that the value of the first index of the first parameter set is better than the value of the first index of the second parameter set, and the value of the second index of the second parameter set is better than the value of the second index of the first parameter set.

(12) In the program, the first function may include a function of displaying three or more indexes for evaluation of the control result of the robot on the display unit, and a function of determining the first index and the second index from the three or more indexes according to an instruction from a user.

(13) In the program, the sixth function may include a function of displaying a graph on the display unit based on the values of the first index and the values of the second index of the two or more parameter sets.

(14) In the program, the two or more parameter sets may include parameter sets being Pareto solutions respectively selected for each of a plurality of sections provided for the first index or parameter sets being Pareto solutions respectively selected for each of a plurality of sections provided for the second index.

(15) The program may control the computer to further realize a seventh function of, after executing the sixth function, acquiring a plurality of parameter sets and values of the first index and values of the second index of the respective plurality of parameter sets by repeatedly executing the processing of the third function and the fourth function for a smaller range than that for the processing of the third function and the fourth function performed so far with respect to at least one of the first index and the second index of the parameter set according to an instruction of a re-search from a user, and an eighth function of executing the sixth function with respect to the plurality of parameter sets obtained in the processing of the seventh function.

According to another aspect of the present disclosure, an information processing apparatus that performs display with respect to parameters of a robot is provided. The information processing apparatus includes an index determination unit that determines a first index and a second index for evaluation of a control result of the robot, a first evaluation unit that executes first evaluation processing of acquiring a value of the first index and a value of the second index when the robot is moved using a parameter set for control of the robot, a new parameter determination unit that executes new parameter determination processing of determining a new parameter set using a multi-objective optimization technique with a function containing the first index and the second index as an objective function based on the parameter set and the acquired value of the first index and value of the second index, a second evaluation unit that executes second evaluation processing of acquiring the value of the first index and the value of the second index when the robot is moved using the new parameter set, a parameter acquisition unit that acquires a plurality of parameter sets and values of the first index and values of the second index of the respective plurality of parameter sets by repeatedly executing the new parameter determination processing by the new parameter determination unit and the second evaluation processing by the second evaluation unit, and a display control unit that executes display processing of performing display based on the respective values of the first index and values of the second index with respect to two or more parameter sets of the plurality of parameter sets on a display unit, two or more parameter sets including a first parameter set and a second parameter set, and the first parameter set and the second parameter set satisfying at least one of conditions that the value of the first index of the first parameter set is better than the value of the first index of the second parameter set, and the value of the second index of the second parameter set is better than the value of the second index of the first parameter set.

(17) In the information processing apparatus, the index determination unit may execute processing of displaying three or more indexes for evaluation of the control result of the robot on the display unit, and processing of determining the first index and the second index from the three or more indexes according to an instruction from a user.

(18) In the information processing apparatus, the display control unit may display a graph on the display unit based on the values of the first index and the values of the second index of the two or more parameter sets.

(19) In the information processing apparatus, the two or more parameter sets may include parameter sets being Pareto solutions respectively selected for each of a plurality of sections provided for the first index or parameter sets being Pareto solutions respectively selected for each of a plurality of sections provided for the second index.

(20) The information processing apparatus further includes a re-search unit that, after the display processing by the display control unit, acquires a plurality of parameter sets and values of the first index and values of the second index of the respective plurality of parameter sets by repeatedly executing the new parameter determination processing by the new parameter determination unit and the second evaluation processing by the second evaluation unit for a smaller range than that for the new parameter determination processing by the new parameter determination unit and the second evaluation processing by the second evaluation unit so far with respect to at least one of the first index and the second index of the parameter set according to an instruction of a re-search from a user, wherein the display control unit executes the display processing with respect to the plurality of parameter sets obtained by the re-search unit.

The present disclosure can be realized in other various aspects than the above described aspects. For example, the present disclosure may be realized in aspects of a control apparatus of a robot system, a computer program for realizing functions of the control apparatus, a non-transitory recording medium recording the computer program, or the like.

What is claimed is:

1. A method of performing display with respect to parameters of a robot, comprising:
(a) determining a first index and a second index for evaluation of a working result of the robot;
(b) acquiring a value of the first index and a value of the second index after the robot works using a parameter set for control of the robot;
(c) determining a new parameter set using a multi-objective optimization technique with a function containing the first index and the second index as an objective function, based on the parameter set and the acquired value of the first index and value of the second index;
(d) acquiring the value of the first index and the value of the second index after the robot works using the new parameter set;
(e) acquiring a plurality of parameter sets and values of the first index and values of the second index of the respective plurality of parameter sets, by repeatedly executing (c) and (d); and
(f) performing display on a display unit, based on the respective values of the first index and values of the second index with respect to two or more parameter sets of the plurality of parameter sets,
the two or more parameter sets including a first parameter set and a second parameter set, and
the first parameter set and the second parameter set satisfying at least one of conditions that
the value of the first index of the first parameter set is better than the value of the first index of the second parameter set, and
the value of the second index of the second parameter set is better than the value of the second index of the first parameter set.

2. The method according to claim 1, further comprising (g) receiving an instruction to designate one parameter set of the two or more parameter sets from a user.

3. The method according to claim 1, wherein
(a) includes:
displaying three or more indexes for evaluation of the working result of the robot on the display unit; and
determining the first index and the second index from the three or more indexes according to an instruction from a user.

4. The method according to claim 1, wherein
the value of the first index of the first parameter set is better than the value of the first index of the second parameter set, and
the value of the second index of the second parameter set is better than the value of the second index of the first parameter set.

5. The method according to claim 1, wherein
(f) includes displaying a graph on the display unit based on the values of the first index and the values of the second index of the two or more parameter sets.

6. The method according to claim 1, wherein
(f) includes displaying a list containing items respectively corresponding to the two or more parameter sets and containing the values of the first index and the values of the second index, and the respective items are arranged in an order of the values of the first index or the values of the second index.

7. The method according to claim 6, wherein
the respective items include at least one of a ranking of the first index of the respective two or more parameter sets and a ranking of the second index of the respective two or more parameter sets.

8. The method according to claim 1, wherein
the two or more parameter sets include parameter sets being Pareto solutions respectively selected for each of a plurality of sections provided for the first index or parameter sets being Pareto solutions respectively selected for each of a plurality of sections provided for the second index.

9. The method according to claim 1, further comprising:
(h), after (f), acquiring a plurality of parameter sets and values of the first index and values of the second index of the respective plurality of parameter sets by repeatedly executing (c) and (d) for a smaller range than that for the processing at steps (c) and (d) performed so far with respect to at least one of the first index and the second index of the parameter set according to an instruction of a re-search from a user; and
(i) executing (f) with respect to the plurality of parameter sets obtained at (h).

10. The method according to claim 1, wherein
the two or more parameter sets include three or more parameter sets being Pareto solutions of the plurality of parameter sets.

11. A non-transitory computer-readable storage medium storing a program for controlling a computer to perform display with respect to parameters of a robot, the program for controlling the computer to realize:
a first function of determining a first index and a second index for evaluation of a working result of the robot;
a second function of acquiring a value of the first index and a value of the second index after the robot works using a parameter set for control of the robot;
a third function of determining a new parameter set using a multi-objective optimization technique with a function containing the first index and the second index as an objective function based on the parameter set and the acquired value of the first index and value of the second index;
a fourth function of acquiring the value of the first index and the value of the second index after the robot works using the new parameter set;
a fifth function of acquiring a plurality of parameter sets and values of the first index and values of the second index of the respective plurality of parameter sets, by repeatedly executing the function of determining the new parameter set and the function of acquiring the value of the first index and the value of the second index; and
a sixth function of performing display on a display unit, based on the respective values of the first index and values of the second index with respect to two or more parameter sets of the plurality of parameter sets,
the two or more parameter sets including a first parameter set and a second parameter set, and
the first parameter set and the second parameter set satisfying at least one of conditions that
the value of the first index of the first parameter set is better than the value of the first index of the second parameter set, and
the value of the second index of the second parameter set is better than the value of the second index of the first parameter set.

12. The storage medium according to claim 11, wherein
the first function includes:
a function of displaying three or more indexes for evaluation of the working result of the robot on the display unit; and
a function of determining the first index and the second index from the three or more indexes according to an instruction from a user.

13. The storage medium according to claim 11, wherein
the sixth function includes a function of displaying a graph on the display unit based on the values of the first index and the values of the second index of the two or more parameter sets.

14. The storage medium according to claim 11, wherein
the two or more parameter sets include parameter sets being Pareto solutions respectively selected for each of a plurality of sections provided for the first index or parameter sets being Pareto solutions respectively selected for each of a plurality of sections provided for the second index.

15. The storage medium according to claim 11, the program controlling the computer to further realize:
a seventh function of, after executing the sixth function, acquiring a plurality of parameter sets and values of the first index and values of the second index of the respective plurality of parameter sets by repeatedly executing the processing of the third function and the fourth function for a smaller range than that for the processing of the third function and the fourth function performed so far with respect to at least one of the first index and the second index of the parameter set according to an instruction of a re-search from a user; and
an eighth function of executing the sixth function with respect to the plurality of parameter sets obtained in the processing of the seventh function.

16. An information processing apparatus that performs display with respect to parameters of a robot, comprising:
an index determination unit that determines a first index and a second index for evaluation of a working result of the robot;
a first evaluation unit that executes first evaluation processing of acquiring a value of the first index and a value of the second index after the robot works using a parameter set for control of the robot;
a new parameter determination unit that executes new parameter determination processing of determining a new parameter set using a multi-objective optimization technique with a function containing the first index and the second index as an objective function based on the parameter set and the acquired value of the first index and value of the second index;
a second evaluation unit that executes second evaluation processing of acquiring the value of the first index and the value of the second index after the robot works using the new parameter set;
a parameter acquisition unit that acquires a plurality of parameter sets and values of the first index and values of the second index of the respective plurality of parameter sets, by repeatedly executing the new parameter determination processing by the new parameter determination unit and the second evaluation processing by the second evaluation unit; and
a display control unit that executes display processing of performing display on a display unit, based on the respective values of the first index and values of the second index with respect to two or more parameter sets of the plurality of parameter sets,
the two or more parameter sets including a first parameter set and a second parameter set, and
the first parameter set and the second parameter set satisfying at least one of conditions that
the value of the first index of the first parameter set is better than the value of the first index of the second parameter set, and
the value of the second index of the second parameter set is better than the value of the second index of the first parameter set.

17. The information processing apparatus according to claim 16, wherein
the index determination unit executes:
processing of displaying three or more indexes for evaluation of the working result of the robot on the display unit; and
processing of determining the first index and the second index from the three or more indexes according to an instruction from a user.

18. The information processing apparatus according to claim 16, wherein
the display control unit displays a graph on the display unit based on the values of the first index and the values of the second index of the two or more parameter sets.

19. The information processing apparatus according to claim 16, wherein
the two or more parameter sets include parameter sets being Pareto solutions respectively selected for each of a plurality of sections provided for the first index or parameter sets being Pareto solutions respectively selected for each of a plurality of sections provided for the second index.

20. The information processing apparatus according to claim 16, further comprising:
a re-search unit that, after the display processing by the display control unit, acquires a plurality of parameter sets and values of the first index and values of the second index of the respective plurality of parameter sets by repeatedly executing the new parameter determination processing by the new parameter determination unit and the second evaluation processing by the second evaluation unit for a smaller range than that for the new parameter determination processing by the new parameter determination unit and the second evaluation processing by the second evaluation unit so far with respect to at least one of the value of the first index and the value of the second index of the parameter set according to an instruction of a re-search from a user, wherein
the display control unit executes the display processing with respect to the plurality of parameter sets obtained by the re-search unit.
